(19) United States
(12) Patent Application Publication
(10) Pub. No.: US 2025/0138490 A1
(43) Pub. Date: May 1, 2025

(54) DISTRIBUTED MACHINE LEARNING MODEL RESOURCE ALLOCATION FOR BUILDING MANAGEMENT SYSTEMS

(71) Applicant: Tyco Fire & Security GmbH, Neuhausen am Rheinfall (CH)

(72) Inventor: John M. Sullivan, Land O Lakes, FL (US)

(21) Appl. No.: 18/927,135

(22) Filed: Oct. 25, 2024

Related U.S. Application Data
(60) Provisional application No. 63/594,264, filed on Oct. 30, 2023.

(51) Int. Cl. G05B 13/02

(52) U.S. Cl. CPC G05B 13/0265

(57) ABSTRACT

Systems and methods are disclosed relating to distributed machine learning model resource allocation for building management systems. For example, a system can include at least one of an orchestrator or an optimizer to receive data regarding a workload to be performed using one or more machine learning models. The system can process the data to select one or more computing resources to deploy in order to perform the workload. The system can evaluate, using one or more trigger conditions, one or more characteristics of at least one of the data or the workload to determine to perform the workload.

### CROSS-REFERENCE TO RELATED PATENT APPLICATIONS

This application claims the benefit of and priority to U.S. Provisional Patent Application No. 63/594,264 filed on Oct. 30, 2023, the entirety of which is incorporated by reference herein.

### BACKGROUND

This application relates generally to a building system of a building. This application relates more particularly to systems for managing and processing data of the building system.

Various interactions between building systems, components of building systems, users, technicians, and/or devices managed by users or technicians can utilize algorithms to manage resource allocation for performing a task. However, it can be challenging for computing systems to efficiently complete the task in an effective and reliable manner.

### SUMMARY

One or more aspects relate to building management systems and methods that implement distributed machine learning model resource allocation for building management systems. For example, a building management system can include a plurality of computational resources arranged as a plurality of nodes coupled by a network, each computational resource of the plurality of computational resources including one or more processors and memory for use by one or more corresponding nodes of the plurality of nodes. The plurality of nodes can include a deployment node. The deployment node can evaluate an output from a given node of the plurality of nodes to determine that a trigger condition for deployment of at least one machine learning model is satisfied, the at least one machine learning model to process the output. The deployment node can determine, responsive to the trigger condition being satisfied, a capability of each node of the plurality of nodes to deploy the at least one machine learning model to process the output. The deployment node can select, according to the capability of each node and one or more resource criteria, from the plurality of nodes, a selected one or more nodes on which to deploy the at least one machine learning model. The deployment node can cause the selected one or more nodes to operate the at least one machine learning model to process the output. The plurality of nodes can include or be associated with one or more neural network systems (e.g., to implement the at least one machine learning model) of a pool of neural network systems. The machine learning model can include various machine learning model architectures (e.g., networks, backbones, algorithms, etc.), including but not limited to language models, LLMs, attention-based neural networks, transformer-based neural networks, generative pretrained transformer (GPT) models, bidirectional encoder representations from transformers (BERT) models, encoder/decoder models, sequence to sequence models, autoencoder models, generative adversarial networks (GANs), convolutional neural networks (CNNs), recurrent neural networks (RNNs), diffusion models (e.g., denoising diffusion probabilistic models (DDPMs)), or various combinations thereof.

At least one aspect relates to a system. The system can include one or more processors to receive data from an item of equipment of a building management system. The one or more processors can determine that the received data is to be processed by at least one machine learning model. The one or more processors can retrieve, for each computing device of a plurality of computing devices of the building management system, an indication of a workload capability of the computing device during at least one of a current period or a future period. The one or more processors can retrieve one or more performance criteria regarding execution of the at least one machine learning model. The one or more processors can select, according to (1) the indication of the workload capacity of each computing device of the plurality of computing devices and (2) the one or more performance criteria, a selected one or more computing devices of the plurality of computing devices. The one or more processors can cause the selected one or more computing devices to deploy the at least one machine learning model to process the data from the item of equipment using the at least one machine learning model.

At least one aspect relates to a method. The method can include receiving, by one or more processors of a building management system, data from one or more devices of the building management system, the one or more devices corresponding to a plurality of computational resources associated with the building management system, the plurality of computational resources including an edge device associated with the building management system and a cloud server associated with the building management system. The method can include generating, by the one or more processors, a first output responsive to the data. The method can include detecting, by the one or more processors, that a trigger condition is satisfied responsive to detecting a target characteristic from the first output. The method can include triggering, by the one or more processors responsive to detecting that the trigger condition is satisfied, a machine learning model deployment process. The machine learning model deployment process can include identifying, by the one or more processors, at least one machine learning model for processing at least one of the data or the first output; selecting, by the one or more processors, according to one or more resource criteria regarding the at least one machine learning model, from the plurality of computational resources associated with the building management system, a selected one or more computational resources on which to deploy the at least one machine learning model on the one or more computational resources, and causing the at least one machine learning model to process the at least one of the data or the first output using the selected one or more computational resources.

At least one aspect relates to a method of deploying machine learning models in building management systems. The method can include receiving, by one or more processors of a building management system, data from one or more devices of the building management system. The one or more devices can correspond to a plurality of computational resources associated with the building management system. The plurality of computational resources can include an edge device associated with the building management system and a cloud server associated with the building management system. The method can include generating, by the one or more processors, a first output responsive to the data. The method can include detecting, by the one or more processors, that a trigger condition is satisfied responsive to detecting a target characteristic from the first output. The method can include triggering, by the one or more processors responsive to detecting that the trigger condition is satisfied, a machine learning model deployment process. The machine learning deployment processes may include identifying, by the one or more processors, at least one machine learning model for processing at least one of the data or the first output. The machine learning deployment process may include selecting, by the one or more processors, according to one or more resource criteria regarding the at least one machine learning model, from the plurality of computational resources associated with the building management system, one or more computational resources on which to deploy the at least one machine learning model on the one or more computational resources. The machine learning deployment process may include causing the at least one machine learning model to process the at least one of the data or the first output using the one or more computational resources.

In some embodiments, the one or more resource criteria represent, for the plurality of computational resources, at least one of an energy usage for operating the at least one machine learning model, an environmental impact score for operating the at least one machine learning model, a device capability relative to operating the at least one machine learning model, a resource availability relative to operating the at least one machine learning model, or a network resource usage for communicating the at least one of the data or the first output to the one or more computational resources.

In some embodiments, the method includes monitoring, by the one or more processors, completion of processing of the at least one of the data or the first output, by the at least one machine learning model. The method may include modifying, by the one or more processors, the one or more computational resources according to the monitoring.

In some embodiments, the method includes receiving, by the one or more processors, feedback indicative of a capability of the one or more computational resources to deploy the at least one machine learning model. The method may include updating, by the one or more processors, the selection of the one or more computational resources responsive to the feedback.

In some embodiments, the method includes selecting the one or more computational resources comprises retrieving, by the one or more processors, a priority score assigned to the one or more computational resources, the priority score corresponding to a capability of the one or more computational resources to execute the at least one machine learning model relative to one or more additional processes being performed by the one or more computational resources.

In some embodiments, the method includes evaluating, by the one or more processors, execution of the at least one machine learning model. The method may include updating, by the one or more processors, the one or more resource criteria according to the evaluation.

In some embodiments, the plurality of computational resources include the one or more processors.

In some embodiments, the plurality of computational resources include an edge device coupled with an internal network of the building management system and a cloud server coupled with an external network coupled with the internal network, the cloud server having a greater computational capacity than the edge device.

In some embodiments, the target characteristic includes a type of data indicated by the first output.

In some embodiments, the method includes transmitting, by the one or more processors, the at least one machine learning model to the one or more computational resources.

In some embodiments, the data comprises at least one of sensor data generated by a sensor of the one or more devices, a input received via a user interface of the one or more devices, equipment data generated by an item of equipment of the one or more devices, an output from a machine learning model operated on the one or more devices, or an output from a generative artificial intelligence (AI) machine learning model implemented by the one or more devices.

At least one aspect relates to a building management system. The building management system may include a plurality of computational resources arranged as a plurality of nodes coupled by a network, each computational resource of the plurality of computational resources comprising one or more processors and memory for use by one or more corresponding nodes of the plurality of nodes. The plurality of nodes may include a deployment node configured to evaluate an output from a given node of the plurality of nodes to determine that a trigger condition for deployment of at least one machine learning model is satisfied, the at least one machine learning model to process the output. The deployment node may be configured to determine, responsive to the trigger condition being satisfied, a capability of each node of the plurality of nodes to deploy the at least one machine learning model to process the output. The deployment node may be configured to select, according to the capability of each node and one or more resource criteria, from the plurality of nodes, one or more nodes on which to deploy the at least one machine learning model. The deployment node may be configured to cause the one or more nodes to operate the at least one machine learning model to process the output.

In some embodiments, the plurality of nodes include a sensor, an edge device, and a cloud server.

In some embodiments, the one or more resource criteria represent, for deployment of the at least one machine learning model on the one or more nodes, at least one of an energy usage, an environmental impact score, or a network resource usage for communication of the output to the one or more nodes.

In some embodiments, the deployment node is configured to monitor completion of the operation of the at least one machine learning model, and modify the selection of the one or more nodes according to the monitoring of the completion.

In some embodiments, the deployment node is configured to select the one or more nodes according to a priority score assigned to the one or more nodes, the priority score corresponding to a capability of the one or more nodes to execute the at least one machine learning model relative to one or more additional processes being performed by the one or more nodes.

In some embodiments, the deployment node is configured to determine that the trigger condition is satisfied responsive to the output having a characteristic matching a target characteristic for use of the at least one machine learning model.

At least one aspect relates to a system. The system may include one or more processors configured to receive data from an item of equipment of a building management system. The one or more processors may be configured to determine that the data is to be processed by at least one machine learning model. The one or more processors may be configured to retrieve, for each computing device of a plurality of computing devices of the building management system, an indication of a workload capability of each computing device of the plurality of computing devices during at least one of a current period or a future period. The one or more processors may be configured to retrieve one or more performance criteria regarding execution of the at least one machine learning model. The one or more processors may be configured to select, according to (1) the indication of the workload capability of each computing device of the plurality of computing devices and (2) the one or more performance criteria, one or more computing devices of the plurality of computing devices. The one or more processors may be configured to cause the one or more computing devices to deploy the at least one machine learning model to process the data from the item of equipment using the at least one machine learning model.

In some embodiments, the plurality of computing devices include a sensor, one or more edge devices of the building management system, and a cloud server coupled with the one or more edge devices.

In some embodiments, the one or more performance criteria comprise at least one of an energy usage score, an environmental impact score, or a network communication score.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a block diagram of an example of a machine learning model-based system for resource allocation applications.

FIG. 2 is a block diagram of an example of a language model-based system for resource allocation applications.

FIG. 3 is a block diagram of an example of the system of FIG. 2 including user application session components.

FIG. 4 is a block diagram of an example of the system of FIG. 2 including feedback training components.

FIG. 5 is a block diagram of an example of the system of FIG. 2 including data filters.

FIG. 6 is a block diagram of an example of the system of FIG. 2 including data validation components.

FIG. 7 is a block diagram of an example of the system of FIG. 2 including expert review and intervention components.

FIG. 8 is a flow diagram of a method of implementing generative artificial intelligence architectures and validation processes for machine learning algorithms for building management systems.

FIG. 9 is a block diagram of an example of a machine learning model-based system for resource allocation applications.

FIG. 10 is a flow diagram of a method of implementing generative artificial intelligence architectures and validation processes for machine learning algorithms for building management systems.

FIG. 11 is a block diagram of an example of a machine learning model-based system for resource allocation applications.

FIG. 12 is a block diagram of an example of a machine learning model-based system for resource allocation applications.

### DETAILED DESCRIPTION

Referring generally to the FIGURES, systems, and methods in accordance with the present disclosure can implement various systems to allocate resources relating to operations to be performed for managing building systems and components and/or items of equipment, including heating, ventilation, cooling, and/or refrigeration (HVAC-R) systems and components. For example, various systems described herein can be implemented to more precisely allocate workloads for various applications including, for example and without limitation, monitoring of an area via sensors (e.g., video, image, air, moisture, and temperature sensors, etc.), virtual assistance for supporting technicians responding to service requests; generating technical reports corresponding to service requests; facilitating diagnostics and troubleshooting procedures; recommendations of services to be performed; and/or recommendations for products or tools to use or install as part of service operations. Various such applications can facilitate resource allocation operations, including by allocating workloads and/or machine learning models between various systems (e.g., edge device, gateway device, server, cloud system, etc.).

AI and/or machine learning (ML) systems, including but not limited to LLMs, can be used to generate text data and data of other modalities in a more responsive manner to real-time conditions, including generating strings of text data that may not be provided in the same manner in existing documents, yet may still meet criteria for useful text information, such as relevance, style, and coherence. For example, LLMs can predict text data based at least on inputted prompts and by being configured (e.g., trained, modified, updated, fine-tuned) according to training data representative of the text data to predict or otherwise generate.

However, various considerations may limit the ability of such systems to precisely generate appropriate data for specific conditions. For example, due to the predictive nature of the generated data, some LLMs may generate text data that is incorrect, imprecise, or not relevant to the specific conditions. Using the LLMs may require a user to manually vary the content and/or syntax of inputs provided to the LLMs (e.g., vary inputted prompts) until the output of the LLMs meets various objective or subjective criteria of the user. The LLMs can have token limits for sizes of inputted text during training and/or runtime/inference operations (and relaxing or increasing such limits may require increased computational processing, API calls to LLM services, and/or memory usage), limiting the ability of the LLMs to be effectively configured or operated using large amounts of raw data or otherwise unstructured data. In some instances, relatively large LLMs, such as LLMs having billions or trillions of parameters, may be less agile in responding to novel queries or applications. In addition, various LLMs may lack transparency, such as to be unable to provide to a user a conceptual/semantic-level explanation of a given output was generated and/or selected relative to other possible outputs.

Systems and methods in accordance with the present disclosure can use machine learning models, including LLMs and other generative AI systems, to capture data, including but not limited to unstructured knowledge from various data sources, and process the data to accurately generate outputs, such as completions responsive to prompts, including in structured data formats for various applications and use cases. The system can implement various automated and/or expert-based thresholds and data quality management processes to improve the accuracy and quality of generated outputs and update training of the machine learning models accordingly. The system can enable real-time messaging and/or conversational interfaces for users to provide field data regarding equipment to the system (including presenting targeted queries to users that are expected to elicit relevant responses for efficiently receiving useful response information from users) and guide users, such as service technicians, through relevant service, diagnostic, troubleshooting, and/or repair processes.

This can include, for example, receiving data from technician service reports in various formats, including various modalities and/or multi-modal formats (e.g., text, speech, audio, image, and/or video). The system can facilitate automated, flexible customer report generation, such as by processing information received from service technicians and other users into a standardized format, which can reduce the constraints on how the user submits data while improving resulting reports. The system can couple unstructured service data to other input/output data sources and analytics, such as to relate unstructured data with outputs of timeseries data from equipment (e.g., sensor data; report logs) and/or outputs from models or algorithms of equipment operation, which can facilitate more accurate analytics, prediction services, diagnostics, and/or fault detection. The system can perform classification or other pattern recognition or trend detection operations to facilitate more timely assignment of technicians, scheduling of technicians based on expected times for jobs, and provisioning of trucks, tools, and/or parts. The system can perform root cause prediction by being trained using data that includes indications of root causes of faults or errors, where the indications are labels for or otherwise associated with (unstructured or structure) data such as service requests, service reports, service calls, etc. The system can receive, from a service technician in the field evaluating the issue with the equipment, feedback regarding the accuracy of the root cause predictions, as well as feedback regarding how the service technician evaluated information about the equipment (e.g., what data did they evaluate; what did they inspect; did the root cause prediction or instructions for finding the root cause accurately match the type of equipment, etc.), which can be used to update the root cause prediction model.

For example, the system can provide a platform for fault detection and servicing processes in which a machine learning model is configured based on connecting or relating unstructured data and/or semantic data, such as human feedback and written/spoken reports, with time-series product data regarding items of equipment, so that the machine learning model can more accurately detect causes of alarms or other events that may trigger service responses. For instance, responsive to an alarm for a chiller, the system can more accurately detect a cause of the alarm, and generate a prescription (e.g., for a service technician) for responding to the alarm; the system can request feedback from the service technician regarding the prescription, such as whether the prescription correctly identified the cause of the alarm and/or actions to perform to respond to the cause, as well as the information that the service technician used to evaluate the correctness or accuracy of the prescription; the system can use this feedback to modify the machine learning models, which can increase the accuracy of the machine learning models. In some implementations, the system can predict the fault condition (e.g., detect an indication of the fault condition prior to the fault condition occurring). The system can determine one or more actions to perform to prevent the fault condition from occurring, such as modifications to equipment operations, or preventative maintenance actions. The system can generate a report, responsive to predicting the fault condition, which identifies the one or more actions.

In some instances, significant computational resources (or human user resources) can be required to process data relating to equipment operation, such as time-series product data and/or sensor data, to detect or predict faults and/or causes of faults. In addition, it can be resource-intensive to label such data with identifiers of faults or causes of faults, which can make it difficult to generate machine learning training data from such data. Systems and methods in accordance with the present disclosure can leverage the efficiency of language models (e.g., GPT-based models or other pre-trained LLMs) in extracting semantic information (e.g., semantic information identifying faults, causes of faults, and other accurate expert knowledge regarding equipment servicing) from the unstructured data in order to use both the unstructured data and the data relating to equipment operation to generate more accurate outputs regarding equipment servicing. As such, by implementing language models using various operations and processes described herein, building management and equipment servicing systems can take advantage of the causal/semantic associations between the unstructured data and the data relating to equipment operation, and the language models can allow these systems to more efficiently extract these relationships in order to more accurately predict targeted, useful information for servicing applications at inference-time/runtime. While various implementations are described as being implemented using generative AI models such as transformers and/or GANs, in some embodiments, various features described herein can be implemented using non-generative AI models or even without using AI/machine learning, and all such modifications fall within the scope of the present disclosure.

The system can enable a generative AI-based service wizard interface. For example, the interface can include user interface and/or user experience features configured to provide a question/answer-based input/output format, such as a conversational interface, that directs users through providing targeted information for accurately generating predictions of root cause, presenting solutions, or presenting instructions for repairing or inspecting the equipment to identify information that the system can use to detect root causes or other issues. The system can use the interface to present information regarding parts and/or tools to service the equipment, as well as instructions for how to use the parts and/or tools to service the equipment.

In various implementations, the systems can include a plurality of machine learning models that may be configured using integrated or disparate data sources. This can facilitate more integrated user experiences or more specialized (and/or lower computational usage for) data processing and output generation. Outputs from one or more first systems, such as one or more first algorithms or machine learning models, can be provided at least as part of inputs to one or more second systems, such as one or more second algorithms or machine learning models. For example, a first language model can be configured to process unstructured inputs (e.g., text, speech, images, etc.) into a structure output format compatible for use by a second system, such as a root cause prediction algorithm or equipment configuration model.

The system can be used to automate interventions for equipment operation, servicing, fault detection and diagnostics (FDD), and alerting operations. For example, by being configured to perform operations such as root cause prediction, the system can monitor data regarding equipment to predict events associated with faults and trigger responses such as alerts, service scheduling, and initiating FDD or modifications to configuration of the equipment. The system can present to a technician or manager of the equipment a report regarding the intervention (e.g., action taken responsive to predicting a fault or root cause condition) and requesting feedback regarding the accuracy of the intervention, which can be used to update the machine learning models to more accurately generate interventions.

### I. Machine Learning Models for Building Management Systems

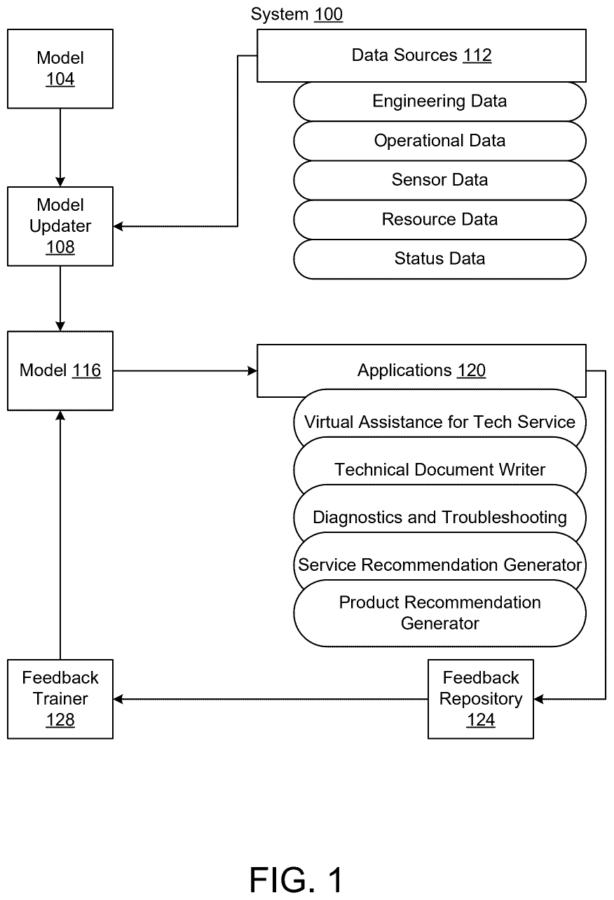

FIG. 1 depicts an example of a system 100. The system 100 can implement various operations for configuring (e.g., training, updating, modifying, transfer learning, fine-tuning, etc.) and/or operating various AI and/or ML systems, such as neural networks of LLMs or other generative AI systems. The system 100 can be used to implement various generative AI-based building equipment servicing operations.

For example, the system 100 can be implemented for operations associated with any of a variety of building management systems (BMSs) or equipment or components thereof. A BMS can include a system of devices that can control, monitor, and manage equipment in or around a building or building area. The BMS can include, for example, a HVAC system, a security system, a lighting system, a fire alerting system, any other system that is capable of managing building functions or devices, or any combination thereof. The BMS can include or be coupled with items of equipment, for example and without limitation, such as heaters, chillers, boilers, air handling units, sensors, actuators, refrigeration systems, fans, blowers, heat exchangers, energy storage devices, condensers, valves, or various combinations thereof.

The items of equipment can operate in accordance with various qualitative and quantitative parameters, variables, setpoints, and/or thresholds or other criteria, for example. In some instances, the system 100 and/or the items of equipment can include or be coupled with one or more controllers for controlling parameters of the items of equipment, such as to receive control commands for controlling operation of the items of equipment via one or more wired, wireless, and/or user interfaces of controller.

Various components of the system 100 or portions thereof can be implemented by one or more processors coupled with or more memory devices (memory). The processors can be a general purpose or specific purpose processors, an application specific integrated circuit (ASIC), one or more field programmable gate arrays (FPGAs), a group of processing components, or other suitable processing components. The processors may be configured to execute computer code and/or instructions stored in the memories or received from other computer readable media (e.g., CDROM, network storage, a remote server, etc.). The processors can be configured in various computer architectures, such as graphics processing units (GPUs), distributed computing architectures, cloud server architectures, client-server architectures, or various combinations thereof. One or more first processors can be implemented by a first device, such as an edge device, and one or more second processors can be implemented by a second device, such as a server or other device that is communicatively coupled with the first device and may have greater processor and/or memory resources.

The memories can include one or more devices (e.g., memory units, memory devices, storage devices, etc.) for storing data and/or computer code for completing and/or facilitating the various processes described in the present disclosure. The memories can include random access memory (RAM), read-only memory (ROM), hard drive storage, temporary storage, non-volatile memory, flash memory, optical memory, or any other suitable memory for storing software objects and/or computer instructions. The memories can include database components, object code components, script components, or any other type of information structure for supporting the various activities and information structures described in the present disclosure. The memories can be communicably connected to the processors and can include computer code for executing (e.g., by the processors) one or more processes described herein.

### Machine Learning Models

The system 100 can include or be coupled with one or more first models 104. The first model 104 can include one or more neural networks, including neural networks configured as generative models. For example, the first model 104 can predict or generate new data (e.g., artificial data; synthetic data; data not explicitly represented in data used for configuring the first model 104). The first model 104 can generate any of a variety of modalities of data, such as text, speech, audio, images, and/or video data. The neural network can include a plurality of nodes, which may be arranged in layers for providing outputs of one or more nodes of one layer as inputs to one or more nodes of another layer. The neural network can include one or more input layers, one or more hidden layers, and one or more output layers. Each node can include or be associated with parameters such as weights, biases, and/or thresholds, representing how the node can perform computations to process inputs to generate outputs. The parameters of the nodes can be configured by various learning or training operations, such as unsupervised learning, weakly supervised learning, semi-supervised learning, or supervised learning.

The first model 104 can include, for example and without limitation, one or more language models, LLMs, attention-based neural networks, transformer-based neural networks, generative pretrained transformer (GPT) models, bidirectional encoder representations from transformers (BERT) models, encoder/decoder models, sequence to sequence models, autoencoder models, generative adversarial networks (GANs), convolutional neural networks (CNNs), recurrent neural networks (RNNs), diffusion models (e.g., denoising diffusion probabilistic models (DDPMs)), or various combinations thereof.

For example, the first model 104 can include at least one GPT model. The GPT model can receive an input sequence, and can parse the input sequence to determine a sequence of tokens (e.g., words or other semantic units of the input sequence, such as by using Byte Pair Encoding tokenization). The GPT model can include or be coupled with a vocabulary of tokens, which can be represented as a one-hot encoding vector, where each token of the vocabulary has a corresponding index in the encoding vector; as such, the GPT model can convert the input sequence into a modified input sequence, such as by applying an embedding matrix to the token tokens of the input sequence (e.g., using a neural network embedding function), and/or applying positional encoding (e.g., sin-cosine positional encoding) to the tokens of the input sequence. The GPT model can process the modified input sequence to determine a next token in the sequence (e.g., to append to the end of the sequence), such as by determining probability scores indicating the likelihood of one or more candidate tokens being the next token, and selecting the next token according to the probability scores (e.g., selecting the candidate token having the highest probability scores as the next token). For example, the GPT model can apply various attention and/or transformer based operations or networks to the modified input sequence to identify relationships between tokens for detecting the next token to form the output sequence.

The first model 104 can include at least one diffusion model, which can be used to generate image and/or video data. For example, the diffusional model can include a denoising neural network and/or a denoising diffusion probabilistic model neural network. The denoising neural network can be configured by applying noise to one or more training data elements (e.g., images, video frames) to generate noised data, providing the noised data as input to a candidate denoising neural network, causing the candidate denoising neural network to modify the noised data according to a denoising schedule, evaluating a convergence condition based on comparing the modified noised data with the training data instances, and modifying the candidate denoising neural network according to the convergence condition (e.g., modifying weights and/or biases of one or more layers of the neural network). In some implementations, the first model 104 includes a plurality of generative models, such as GPT and diffusion models, which can be trained separately or jointly to facilitate generating multi-modal outputs, such as technical documents (e.g., service guides) that include both text and image/video information.

In some implementations, the first model 104 can be configured using various unsupervised and/or supervised training operations. The first model 104 can be configured using training data from various domain-agnostic and/or domain-specific data sources, including but not limited to various forms of text, speech, audio, image, and/or video data, or various combinations thereof. The training data can include a plurality of training data elements (e.g., training data instances). Each training data element can be arranged in structured or unstructured formats; for example, the training data element can include an example output mapped to an example input, such as a query representing a workload, a task, or a data stream, a number of resources, and a response representing data (e.g., which machine learning model to use for the query, which system to use for the query) provided responsive to the query. The training data can include data that is not separated into input and output subsets (e.g., for configuring the first model 104 to perform clustering, classification, or other unsupervised ML operations). The training data can include human-labeled information, including but not limited to feedback regarding outputs of the model 104 or the model 116. This can allow the system 100 to generate more human-like outputs.

In some implementations, the training data includes data relating to building management systems. For example, the training data can include examples of HVAC-R data, such as operating manuals, technical data sheets, configuration settings, operating setpoints, diagnostic guides, troubleshooting guides, user reports, technician reports. In some implementations, the training data used to configure the first model 104 includes at least some publicly accessible data, such as data retrievable via the Internet.

Referring further to FIG. 1, the system 100 can configure the first model 104 to determine one or more second models 116. For example, the system 100 can include a model updater 108 that configures (e.g., trains, updates, modifies, fine-tunes, etc.) the first model 104 to determine the one or more second models 116. In some implementations, the second model 116 can be used to provide application-specific outputs, such as outputs having greater precision, accuracy, or other metrics, relative to the first model, for targeted applications.

The second model 116 can be similar to the first model 104. For example, the second model 116 can have a similar or identical backbone or neural network architecture as the first model 104. In some implementations, the first model 104 and the second model 116 each include generative AI machine learning models, such as LLMs (e.g., GPT-based LLMs) and/or diffusion models. The second model 116 can be configured using processes analogous to those described for configuring the first model 104.

In some implementations, the model updater 108 can perform operations on at least one of the first model 104 or the second model 116 via one or more interfaces, such as application programming interfaces (APIs). For example, the models 104, 116 can be operated and maintained by one or more systems separate from the system 100. The model updater 108 can provide training data to the first model 104, via the API, to determine the second model 116 based on the first model 104 and the training data. The model updater 108 can control various training parameters or hyperparameters (e.g., learning rates, etc.) by providing instructions via the API to manage configuring the second model 116 using the first model 104.

### Data Sources

The model updater 108 can determine the second model 116 using data from one or more data sources 112. For example, the system 100 can determine the second model 116 by modifying the first model 104 using data from the one or more data sources 112. The data sources 112 can include or be coupled with any of a variety of integrated or disparate databases, data warehouses, digital twin data structures (e.g., digital twins of items of equipment or building management systems or portions thereof), data lakes, data repositories, documentation records, or various combinations thereof. In some implementations, the data sources 112 include HVAC-R data in any of text, speech, audio, image, or video data, or various combinations thereof, such as data associated with HVAC-R components and procedures including but not limited to installation, operation, configuration, repair, servicing, diagnostics, and/or troubleshooting of HVAC-R components and systems. Various data described below with reference to data sources 112 may be provided in the same or different data elements, and may be updated at various points. The data sources 112 can include or be coupled with items of equipment (e.g., where the items of equipment output data for the data sources 112, such as sensor data, etc.). The data sources 112 can include various online and/or social media sources, such as blog posts or data submitted to applications maintained by entities that manage the buildings. The system 100 can determine relations between data from different sources, such as by using timeseries information and identifiers of the sites or buildings at which items of equipment are present to detect relationships between various different data relating to the items of equipment (e.g., to train the models 104, 116 using both timeseries data (e.g., sensor data; outputs of algorithms or models, etc.) regarding a given item of equipment and freeform natural language reports regarding the given item of equipment).

The data sources 112 can include unstructured data or structured data (e.g., data that is labeled with or assigned to one or more predetermined fields or identifiers, or is in a predetermined format, such as a database or tabular format). The unstructured data can include one or more data elements that are not in a predetermined format (e.g., are not assigned to fields, or labeled with or assigned with identifiers, which are indicative of a characteristic of the one or more data elements). The data sources 112 can include semi-structured data, such as data assigned to one or more fields that may not specify at least some characteristics of the data, such as data represented in a report having one or more fields to which freeform data is assigned (e.g., a report having a field labeled “describe the item of equipment” in which text or user input describing the item of equipment is provided). The data sources 112 can include data that is incomplete,

For example, using the first model 104 and/or second model 116 to process the data can allow the system 100 to extract useful information from data in a variety of formats, including unstructured/freeform formats, which can allow technicians to input information in less burdensome formats. The data can be of any of a plurality of formats (e.g., text, speech, audio, image, video, etc.), including multi-modal formats. For example, the data may be received from technicians in forms such as text (e.g., laptop/desktop or mobile application text entry), audio, and/or video (e.g., dictating findings while capturing video).

The data sources 112 can include engineering data regarding one or more items of equipment. The engineering data can include manuals, such as installation manuals, instruction manuals, or operating procedure guides. The engineering data can include specifications or other information regarding operation of items of equipment. The engineering data can include engineering drawings, process flow diagrams, refrigeration cycle parameters (e.g., temperatures, pressures), or various other information relating to structures and functions of items of equipment.

In some implementations, the data sources 112 can include operational data regarding one or more items of equipment. The operational data can represent detected information regarding items of equipment, such as sensor data, logged data, user reports, or technician reports. The operational data can include, for example, service tickets generated responsive to requests for service, work orders, tasks, data from digital twin data structures maintained by an entity of the item of equipment, outputs, or other information from equipment operation models (e.g., chiller vibration models), or various combinations thereof. Logged data, user reports, service tickets, billing records, time sheets, and various other such data can provide temporal information, such as how many resources (e.g., time, computational power, latency, bandwidth, power, memory, etc.) an operation (e.g., execution of one or more operations using machine learning models) may take, which can allow the system 100 to predict resources to use for performing the operation as well as what system and/or machine learning model to use for servicing (e.g., executing, performing) the operation.

The data sources 112 can include, for instance, sensor data. The sensor data can include video data, temperature data, or other types of sensor data that indicate conditions of items of equipment or other actions corresponding to items of equipment, such as actions corresponding to work loads.

The data sources 112 can include resource data. The resource data can include data from any of various systems, such as edge devices or service providers. The resource data can indicate what resources the various systems have available to perform workload procedures, including associated service procedures with initial service requests and/or sensor data related conditions to trigger service and/or sensor data measured during service processes.

In some implementations, the data sources 112 can include status data. For example, the data sources 112 can indicate availability of the data sources 112 or a status of one or more workloads assigned to the data sources 112.

The system 100 can include, with the data of the data sources 112, labels to facilitate cross-reference between items of data that may relate to common items of equipment, sites, service technicians, customers, or various combinations thereof. For example, data from disparate sources may be labeled with time data, which can allow the system 100 (e.g., by configuring the models 104, 116) to increase a likelihood of associating information from the disparate sources due to the information being detected or recorded (e.g., as service reports) at the same time or near in time.

For example, the data sources 112 can include data that can be particular to specific or similar items of equipment, buildings, equipment configurations, environmental states, or various combinations thereof. In some implementations, the data includes labels or identifiers of such information, such as to indicate locations, weather conditions, timing information, uses of the items of equipment or the buildings or sites at which the items of equipment are present, etc. This can enable the models 104, 116 to detect patterns of usage (e.g., spikes; troughs; seasonal or other temporal patterns) or other information that may be useful for determining causes of issues or causes of service requests, or predict future issues, such as to allow the models 104, 116 to be trained using information indicative of causes of issues across multiple items of equipment (which may have the same or similar causes even if the data regarding the items of equipment is not identical). For example, an item of equipment may be at a site that is a museum; by relating site usage or occupancy data with data regarding the item of equipment, such as sensor data and service reports, the system 100 can configure the models 104, 116 to determine a high likelihood of issues occurring before events associated with high usage (e.g., gala, major exhibit opening), and can generate recommendations to perform diagnostics or servicing prior to the events.

### Model Configuration

Referring further to FIG. 1, the model updater 108 can perform various machine learning model configuration/training operations to determine the second models 116 using the data from the data sources 112. For example, the model updater 108 can perform various updating, optimization, retraining, reconfiguration, fine-tuning, or transfer learning operations, or various combinations thereof, to determine the second models 116. The model updater 108 can configure the second models 116, using the data sources 112, to generate outputs (e.g., completions) in response to receiving inputs (e.g., prompts), where the inputs and outputs can be analogous to data of the data sources 112.

For example, the model updater 108 can identify one or more parameters (e.g., weights and/or biases) of one or more layers of the first model 104, and maintain (e.g., freeze, maintain as the identified values while updating) the values of the one or more parameters of the one or more layers. In some implementations, the model updater 108 can modify the one or more layers, such as to add, remove, or change an output layer of the one or more layers, or to not maintain the values of the one or more parameters. The model updater 108 can select at least a subset of the identified one or parameters to maintain according to various criteria, such as user input or other instructions indicative of an extent to which the first model 104 is to be modified to determine the second model 116. In some implementations, the model updater 108 can modify the first model 104 so that an output layer of the first model 104 corresponds to output to be determined for applications 120.

Responsive to selecting the one or more parameters to maintain, the model updater 108 can apply, as input to the second model 116 (e.g., to a candidate second model 116, such as the modified first model 104, such as the first model 104 having the identified parameters maintained as the identified values), training data from the data sources 112. For example, the model updater 108 can apply the training data as input to the second model 116 to cause the second model 116 to generate one or more candidate outputs.

The model updater 108 can evaluate a convergence condition to modify the candidate second model 116 based at least on the one or more candidate outputs and the training data applied as input to the candidate second model 116. For example, the model updater 108 can evaluate an objective function of the convergence condition, such as a loss function (e.g., L1 loss, L2 loss, root mean square error, cross-entropy or log loss, etc.) based on the one or more candidate outputs and the training data; this evaluation can indicate how closely the candidate outputs generated by the candidate second model 116 correspond to the ground truth represented by the training data. The model updater 108 can use any of a variety of optimization algorithms (e.g., gradient descent, stochastic descent, Adam optimization, etc.) to modify one or more parameters (e.g., weights or biases of the layer(s) of the candidate second model 116 that are not frozen) of the candidate second model 116 according to the evaluation of the objective function. In some implementations, the model updater 108 can use various hyperparameters to evaluate the convergence condition and/or perform the configuration of the candidate second model 116 to determine the second model 116, including but not limited to hyperparameters such as learning rates, numbers of iterations or epochs of training, etc.

As described further herein with respect to applications 120, in some implementations, the model updater 108 can select the training data from the data of the data sources 112 to apply as the input based at least on a particular application of the plurality of applications 120 for which the second model 116 is to be used for. For example, the model updater 108 can select data from the parts data source 112 for the product recommendation generator application 120 or select various combinations of data from the data sources 112 (e.g., engineering data, operational data, sensor data, resource data, status data) for the service recommendation generator application 120. The model updater 108 can apply various combinations of data from various data sources 112 to facilitate configuring the second model 116 for one or more applications 120.

In some implementations, the system 100 can perform at least one of conditioning, classifier-based guidance, or classifier-free guidance to configure the second model 116 using the data from the data sources 112. For example, the system 100 can use classifiers associated with the data, such as identifiers of the item of equipment, a type of the item of equipment, a type of entity operating the item of equipment, a site at which the item of equipment is provided, or a history of issues at the site, to condition the training of the second model 116. For example, the system 100 combine (e.g., concatenate) various such classifiers with the data for inputting to the second model 116 during training, for at least a subset of the data used to configure the second model 116, which can enable the second model 116 to be responsive to analogous information for runtime/inference time operations.

### Applications

Referring further to FIG. 1, the system 100 can use outputs of the one or more second models 116 to implement one or more applications 120. For example, the second models 116, having been configured using data from the data sources 112, can be capable of precisely generating outputs that represent useful, timely, and/or real-time information for the applications 120. In some implementations, each application 120 is coupled with a corresponding second model 116 that is specifically configured to generate outputs for use by the application 120. Various applications 120 can be coupled with one another, such as to provide outputs from a first application 120 as inputs or portions of inputs to a second application 120.

The applications 120 can include any of a variety of desktop, web-based/browser-based, or mobile applications. For example, the applications 120 can be implemented by enterprise management software systems, employee, or other user applications (e.g., applications that relate to BMS functionality such as temperature control, user preferences, conference room scheduling, etc.), equipment portals that provide data regarding items of equipment, or various combinations thereof.

The applications 120 can include user interfaces, dashboards, wizards, checklists, conversational interfaces, chatbots, configuration tools, or various combinations thereof. The applications 120 can receive an input, such as a prompt (e.g., from a user), provide the prompt to the second model 116 to cause the second model 116 to generate an output, such as a completion in response to the prompt, and present an indication of the output. The applications 120 can receive inputs and/or present outputs in any of a variety of presentation modalities, such as text, speech, audio, image, and/or video modalities. For example, the applications 120 can receive unstructured or freeform inputs from a user, such as a service technician, and generate reports in a standardized format, such as a customer-specific format. This can allow, for example, technicians to automatically, and flexibly, generate customer-ready reports after service visits without requiring strict input by the technician or manually sitting down and writing reports; to receive inputs as dictations in order to generate reports; to receive inputs in any form or a variety of forms, and use the second model 116 (which can be trained to cross-reference metadata in different portions of inputs and relate together data elements) to generate output reports (e.g., the second model 116, having been configured with data that includes time information, can use timestamps of input from dictation and timestamps of when an image is taken, and place the image in the report in a target position or label based on time correlation).

In some implementations, the applications 120 include at least one virtual assistant (e.g., virtual assistance for technician services) application 120. The virtual assistant application can provide various services to support technician operations, such as presenting information from service requests, receiving queries regarding actions to perform to service items of equipment, and presenting responses indicating actions to perform to service items of equipment. The virtual assistant application can receive information regarding an item of equipment to be serviced, such as sensor data, text descriptions, or camera images, and process the received information using the second model 116 to generate corresponding responses.

For example, the virtual assistant application 120 can be implemented in a UI/UX wizard configuration, such as to provide a sequence of requests for information from the user (the sequence may include requests that are at least one of predetermined or dynamically generated responsive to inputs from the user for previous requests). For example, the virtual assistant application 120 can provide one or more requests for information from users such as service technicians, facility managers, or other occupants, and provide the received responses to at least one of the second model 116 or a root cause detection function (e.g., algorithm, model, data structure mapping inputs to candidate causes, etc.) to determine a prediction of a cause of the issue of the item of equipment and/or solutions. The virtual assistant application 120 can use requests for information such as for unstructured text by which the user describes characteristics of the item of equipment relating to the issue; answers expected to correspond to different scenarios indicative of the issue; and/or image and/or video input (e.g., images of problems, equipment, spaces, etc. that can provide more context around the issue and/or configurations). For example, responsive to receiving a response via the virtual assistant application 120 indicating that the problem is with temperature in the space, the system 100 can request, via the virtual assistant application 120, information regarding HVAC-R equipment associated with the space, such as pictures of the space, an air handling unit, a chiller, or various combinations thereof.

The virtual assistant application 120 can include a plurality of applications 120 (e.g., variations of interfaces or customizations of interfaces) for a plurality of respective user types. For example, the virtual assistant application 120 can include a first application 120 for a customer user, and a second application 120 for a service technician user. The virtual assistant applications 120 can allow for updating and other communications between the first and second applications 120 as well as the second model 116. Using one or more of the first application 120 and the second application 120, the system 100 can manage continuous/real-time conversations for one or more users, and evaluate the users' engagement with the information provided (e.g., did the user, customer, service technician, etc., follow the provided steps for responding to the issue or performing service, did the user discontinue providing inputs to the virtual assistant application 120, etc.), such as to enable the system 100 to update the information generated by the second model 116 for the virtual assistant application 120 according to the engagement. In some implementations, the system 100 can use the second model 116 to detect sentiment of the user of the virtual assistant application 120 and update the second model 116 according to the detected sentiment, such as to improve the experience provided by the virtual assistant application 120.

The applications 120 can include at least one document writer application 120, such as a technical document writer. The document writer application 120 can facilitate preparing structured (e.g., form-based) and/or unstructured documentation, such as documentation associated with service requests. For example, the document writer application 120 can present a user interface corresponding to a template document to be prepared that is associated with at least one of a service request or the item of equipment for which the service request is generated, such as to present one or more predefined form sections or fields. The document writer application 120 can use inputs, such as prompts received from the users and/or technical data provided by the user regarding the item of equipment, such as sensor data, text descriptions, or camera images, to generate information to include in the documentation. For example, the document writer application 120 can provide the inputs to the second model 116 to cause the second model 116 to generate completions for text information to include in the fields of the documentation.

The applications 120 can include, in some implementations, at least one diagnostics and troubleshooting application 120. The diagnostics and troubleshooting application 120 can receive inputs including at least one of a service request or information regarding the item of equipment to be serviced, such as information identified by a service technician. The diagnostics and troubleshooting application 120 can provide the inputs to a corresponding second model 116 to cause the second model 116 to generate outputs such as indications of potential items to be checked regarding the item of equipment, modifications or fixes to make to perform the service, or values or ranges of values of parameters of the item of equipment that may be indicative of specific issues to for the service technician to address or repair.

The applications 120 can include at least one service recommendation generator application 120. The service recommendation generator application 120 can receive inputs such as a service request or information regarding the item of equipment to be serviced, and provide the inputs to the second model 116 to cause the second model 116 to generate outputs for presenting service recommendations, such as actions to perform to address the service request.

In some implementations, the applications 120 can include a product recommendation generator application 120. The product recommendation generator application 120 can process inputs such as information regarding the item of equipment or the service request, using one or more second models 116 (e.g., models trained using parts data from the data sources 112), to determine a recommendation of a part or product to replace or otherwise use for repairing the item of equipment.

### Feedback Training

Referring further to FIG. 1, the system 100 can include at least one feedback trainer 128 coupled with at least one feedback repository 124. The system 100 can use the feedback trainer 128 to increase the precision and/or accuracy of the outputs generated by the second models 116 according to feedback provided by users of the system 100 and/or the applications 120.

The feedback repository 124 can include feedback received from users regarding output presented by the applications 120. For example, for at least a subset of outputs presented by the applications 120, the applications 120 can present one or more user input elements for receiving feedback regarding the outputs. The user input elements can include, for example, indications of binary feedback regarding the outputs (e.g., good/bad feedback; feedback indicating the outputs do or do not meet the user's criteria, such as criteria regarding technical accuracy or precision); indications of multiple levels of feedback (e.g., scoring the outputs on a predetermined scale, such as a 1-5 scale or 1-10 scale); freeform feedback (e.g., text or audio feedback); or various combinations thereof.

The system 100 can store and/or maintain feedback in the feedback repository 124. In some implementations, the system 100 stores the feedback with one or more data elements associated with the feedback, including but not limited to the outputs for which the feedback was received, the second model(s) 116 used to generate the outputs, and/or input information used by the second models 116 to generate the outputs (e.g., service request information; information captured by the user regarding the item of equipment).

The feedback trainer 128 can update the one or more second models 116 using the feedback. The feedback trainer 128 can be similar to the model updater 108. In some implementations, the feedback trainer 128 is implemented by the model updater 108; for example, the model updater 108 can include or be coupled with the feedback trainer 128. The feedback trainer 128 can perform various configuration operations (e.g., retraining, fine-tuning, transfer learning, etc.) on the second models 116 using the feedback from the feedback repository 124. In some implementations, the feedback trainer 128 identifies one or more first parameters of the second model 116 to maintain as having predetermined values (e.g., freeze the weights and/or biases of one or more first layers of the second model 116), and performs a training process, such as a fine tuning process, to configure parameters of one or more second parameters of the second model 116 using the feedback (e.g., one or more second layers of the second model 116, such as output layers or output heads of the second model 116).

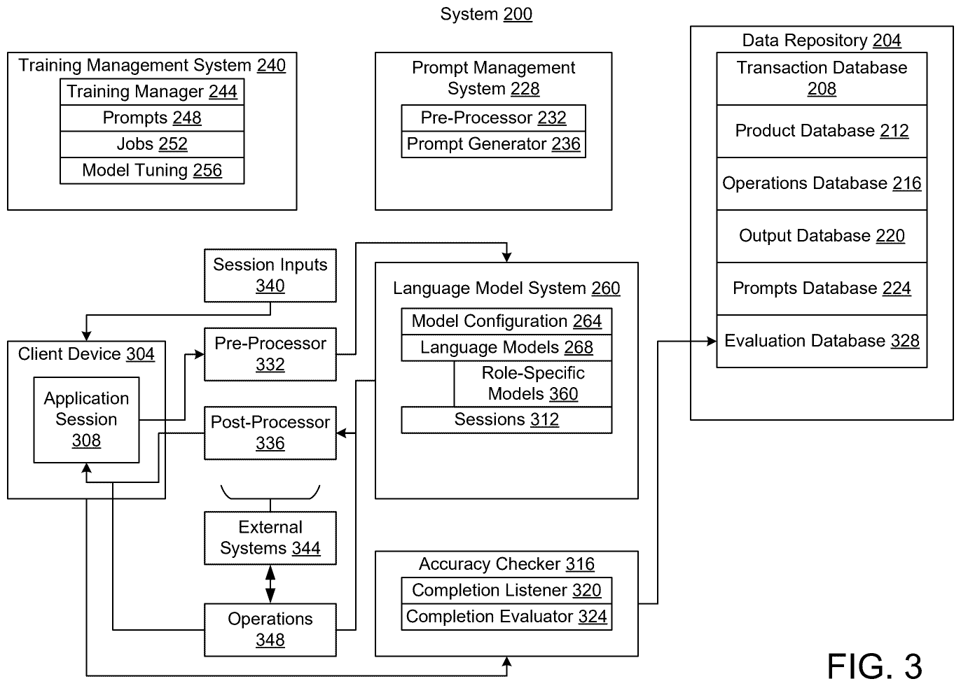

In some implementations, the system 100 may not include and/or use the model updater 108 (or the feedback trainer 128) to determine the second models 116. For example, the system 100 can include or be coupled with an output processor (e.g., an output processor similar or identical to accuracy checker 316 described with reference to FIG. 3) that can evaluate and/or modify outputs from the first model 104 prior to operation of applications 120, including to perform any of various post-processing operations on the output from the first model 104. For example, the output processor can compare outputs of the first model 104 with data from data sources 112 to validate the outputs of the first model 104 and/or modify the outputs of the first model 104 (or output an error) responsive to the outputs not satisfying a validation condition.

### Connected Machine Learning Models

Referring further to FIG. 1, the second model 116 can be coupled with one or more third models, functions, or algorithms for training/configuration and/or runtime operations. The third models can include, for example and without limitation, any of various models relating to items of equipment, such as energy usage models, sustainability models, carbon models, air quality models, or occupant comfort models. For example, the second model 116 can be used to process unstructured information regarding items of equipment into predefined template formats compatible with various third models, such that outputs of the second model 116 can be provided as inputs to the third models; this can allow more accurate training of the third models, more training data to be generated for the third models, and/or more data available for use by the third models. The second model 116 can receive inputs from one or more third models, which can provide greater data to the second model 116 for processing.

The third models may be selected based on one or more resource criteria regarding the third model. In some embodiments, the resource criteria represent an energy usage associated with operating the model. For example, energy usage may be based on a power consumption, grid demand, peak power demand, or other energy usage metrics associated with operating the model. The resource criteria may be updated based on an evaluation of the execution of the third model. For example, the performance of the third model may alter based on its inputs, and the resource criteria may adjust accordingly.

### Automated Service Scheduling and Provisioning

The system 100 can be used to automate operations for scheduling, provisioning, and deploying service technicians and resources for service technicians to perform service operations. For example, the system 100 can use at least one of the first model 104 or the second model 116 to determine, based on processing information regarding service operations for items of equipment relative to completion criteria for the service operation, particular characteristics of service operations such as experience parameters of scheduled service technicians, identifiers of parts provided for the service operations, geographical data, types of customers, types of problems, or information content provided to the service technicians to facilitate the service operation, where such characteristics correspond to the completion criteria being satisfied (e.g., where such characteristics correspond to an increase in likelihood of the completion criteria being satisfied relative to other characteristics for service technicians, parts, information content, etc.). For example, the system 100 can determine, for a given item of equipment, particular parts to include on a truck to be sent to the site of the item of equipment. As such, the system 100, responsive to processing inputs at runtime such as service requests, can automatically and more accurately identify service technicians and parts to direct to the item of equipment for the service operations. The system 100 can use timing information to perform batch scheduling for multiple service operations and/or multiple technicians for the same or multiple service operations. The system 100 can perform batch scheduling for multiple trucks for multiple items of equipment, such as to schedule a first one or more parts having a greater likelihood for satisfying the completion criteria for a first item of equipment on a first truck, and a second one or more parts having a greater likelihood for satisfying the completion criteria for a second item of equipment on a second truck.

### II. System Architectures for Generative AI Applications for Building Management System and Equipment Servicing

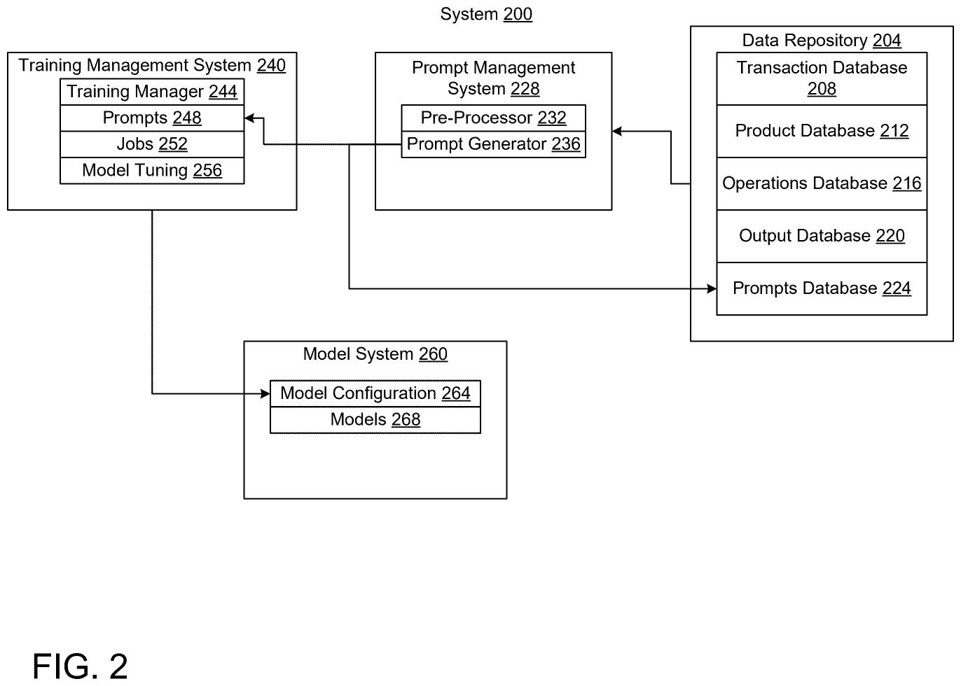

FIG. 2 depicts an example of a system 200. The system 200 can include one or more components or features of the system 100, such as any one or more of the first model 104, data sources 112, second model 116, applications 120, feedback repository 124, and/or feedback trainer 128. The system 200 can perform specific operations to enable generative AI applications for building managements systems and equipment servicing, such as various manners of processing input data into training data (e.g., tokenizing input data; forming input data into prompts and/or completions), and managing training and other machine learning model configuration processes. Various components of the system 200 can be implemented using one or more computer systems, which may be provided on the same or different processors (e.g., processors communicatively coupled via wired and/or wireless connections).

The system 200 can include at least one data repository 204, which can be similar to the data sources 112 described with reference to FIG. 1. For example, the data repository 204 can include a transaction database 208, which can be similar or identical to one or more of warranty data or service data of data sources 112. For example, the transaction database 208 can include data such as parts used for service transactions; sales data indicating various service transactions or other transactions regarding items of equipment; warranty and/or claims data regarding items of equipment; and service data.

The data repository 204 can include a product database 212, which can be similar or identical to the parts data of the data sources 112. The product database 212 can include, for example, data regarding products available from various vendors, specifications or parameters regarding products, and indications of products used for various service operations. The product database 212 can include data such as events or alarms associated with products; logs of product operation; and/or time series data regarding product operation, such as longitudinal data values of operation of products and/or building equipment.

The data repository 204 can include an operations database 216, which can be similar or identical to the operations data of the data sources 112. For example, the operations database 216 can include data such as manuals regarding parts, products, and/or items of equipment; customer service data; and or reports, such as operation or service logs.

In some implementations, the data repository 204 can include an output database 220, which can include data of outputs that may be generated by various machine learning models and/or algorithms. For example, the output database 220 can include values of pre-calculated predictions and/or insights, such as parameters regarding operation items of equipment, such as setpoints, changes in setpoints, flow rates, control schemes, identifications of error conditions, or various combinations thereof.

As depicted in FIG. 2, the system 200 can include a prompt management system 228. The prompt management system 228 can include one or more rules, heuristics, logic, policies, algorithms, functions, machine learning models, neural networks, scripts, or various combinations thereof to perform operations including processing data from data repository 204 into training data for configuring various machine learning models. For example, the prompt management system 228 can retrieve and/or receive data from the data repository 204, and determine training data elements that include examples of input and outputs for generation by machine learning models, such as a training data element that includes a prompt and a completion corresponding to the prompt, based on the data from the data repository 204.

In some implementations, the prompt management system 228 includes a pre-processor 232. The pre-processor 232 can perform various operations to prepare the data from the data repository 204 for prompt generation. For example, the pre-processor 232 can perform any of various filtering, compression, tokenizing, or combining (e.g., combining data from various databases of the data repository 204) operations.

The prompt management system 228 can include a prompt generator 236. The prompt generator 236 can generate, from data of the data repository 204, one or more training data elements that include a prompt and a completion corresponding to the prompt. In some implementations, the prompt generator 236 receives user input indicative of prompt and completion portions of data. For example, the user input can indicate template portions representing prompts of structured data, such as predefined fields or forms of documents, and corresponding completions provided for the documents. The user input can assign prompts to unstructured data. In some implementations, the prompt generator 236 automatically determines prompts and completions from data of the data repository 204, such as by using any of various natural language processing algorithms to detect prompts and completions from data. In some implementations, the system 200 does not identify distinct prompts and completions from data of the data repository 204.

Referring further to FIG. 2, the system 200 can include a training management system 240. The training management system 240 can include one or more rules, heuristics, logic, policies, algorithms, functions, machine learning models, neural networks, scripts, or various combinations thereof to perform operations including controlling training of machine learning models, including performing fine tuning and/or transfer learning operations.

The training management system 240 can include a training manager 244. The training manager 244 can incorporate features of at least one of the model updater 108 or the feedback trainer 128 described with reference to FIG. 1. For example, the training manager 244 can provide training data including a plurality of training data elements (e.g., prompts and corresponding completions) to the model system 260 as described further herein to facilitate training machine learning models.

In some implementations, the training management system 240 includes prompts 248. For example, the training management system 240 can store one or more training data elements from the prompt management system 228, such as to facilitate asynchronous and/or batched training processes.

The training manager 244 can control the training of machine learning models using information or instructions maintained in a model tuning database 256. For example, the training manager 244 can store, in the model tuning database 256, various parameters or hyperparameters for models and/or model training.

In some implementations, the training manager 244 stores a record of training operations in a jobs database 252. For example, the training manager 244 can maintain data such as a queue of training jobs, parameters or hyperparameters to be used for training jobs, or information regarding performance of training.

Referring further to FIG. 2, the system 200 can include at least one model system 260 (e.g., one or more language model systems). The model system 260 can include one or more rules, heuristics, logic, policies, algorithms, functions, machine learning models, neural networks, scripts, or various combinations thereof to perform operations including configuring one or more machine learning models 268 based on instructions from the training management system 240. In some implementations, the training management system 240 implements the model system 260. In some implementations, the training management system 240 can access the model system 260 using one or more APIs, such as to provide training data and/or instructions for configuring machine learning models 268 via the one or more APIs. The model system 260 can operate as a service layer for configuring the machine learning models 268 responsive to instructions from the training management system 240. The machine learning models 268 can be or include the first model 104 and/or second model 116 described with reference to FIG. 1.

The model system 260 can include a model configuration processor 264. The model configuration processor 264 can incorporate features of the model updater 108 and/or the feedback trainer 128 described with reference to FIG. 1. For example, the model configuration processor 264 can apply training data (e.g., prompts 248 and corresponding completions) to the machine learning models 268 to configure (e.g., train, modify, update, fine-tune, etc.) the machine learning models 268. The training manager 244 can control training by the model configuration processor 264 based on model tuning parameters in the model tuning database 256, such as to control various hyperparameters for training. In various implementations, the system 200 can use the training management system 240 to configure the machine learning models 268 in a similar manner as described with reference to the second model 116 of FIG. 1, such as to train the machine learning models 268 using any of various data or combinations of data from the data repository 204.

### Application Session Management

FIG. 3 depicts an example of the system 200, in which the system 200 can perform operations to implement at least one application session 308 for a client device 304. For example, responsive to configuring the machine learning models 268, the system 200 can generate data for presentation by the client device 304 (including generating data responsive to information received from the client device 304) using the at least one application session 308 and the one or more machine learning models 268.

The client device 304 can be a device of a user, such as a technician or building manager. The client device 304 can include any of various wireless or wired communication interfaces to communicate data with the model system 260, such as to provide requests to the model system 260 indicative of data for the machine learning models 268 to generate, and to receive outputs from the model system 260. The client device 304 can include various user input and output devices to facilitate receiving and presenting inputs and outputs.

In some implementations, the system 200 provides data to the client device 304 for the client device 304 to operate the at least one application session 308. The application session 308 can include a session corresponding to any of the applications 120 described with reference to FIG. 1. For example, the client device 304 can launch the application session 308 and provide an interface to request one or more prompts. Responsive to receiving the one or more prompts, the application session 308 can provide the one or more prompts as input to the machine learning model 268. The machine learning model 268 can process the input to generate a completion, and provide the completion to the application session 308 to present via the client device 304. In some implementations, the application session 308 can iteratively generate completions using the machine learning models 268. For example, the machine learning models 268 can receive a first prompt from the application session 308, determine a first completion based on the first prompt and provide the first completion to the application session 308, receive a second prompt from the application session 308, determine a second completion based on the second prompt (which may include at least one of the first prompt or the first completion concatenated to the second prompt), and provide the second completion to the application session 308.

In some implementations, the application session 308 maintains a session state regarding the application session 308. The session state can include one or more prompts received by the application session 308, and can include one or more completions received by the application session 308 from the model system 260. The session state can include one or more items of feedback received regarding the completions, such as feedback indicating accuracy of the completion. The session state may provide for active monitoring of the application session 308. For example, the session state may receive prompts from the application session on a regular (e.g., interval, predetermined) basis to actively monitor completion of processing. Based on the active monitoring of the session state, computational resources may be modified or allocated. For example, depending on the feedback indicating accuracy of the completion, computational resources may be modified, and/or the allocation of computational resources may be modified.

The system 200 can include or be coupled with one or more session inputs 340 or sources thereof. The session inputs 340 can include, for example and without limitation, location-related inputs, such as identifiers of an entity managing an item of equipment or a building or building management system, a jurisdiction (e.g., city, state, country, etc.), a language, or a policy or configuration associated with operation of the item of equipment, building, or building management system. The session inputs 340 can indicate an identifier of the user of the application session 308. The session inputs 340 can include data regarding items of equipment or building management systems, including but not limited to operation data or sensor data. The session inputs 340 can include information from one or more applications, algorithms, simulations, neural networks, machine learning models, or various combinations thereof, such as to provide analyses, predictions, or other information regarding items of equipment. The session inputs 340 can data from or analogous to the data of the data repository 204.

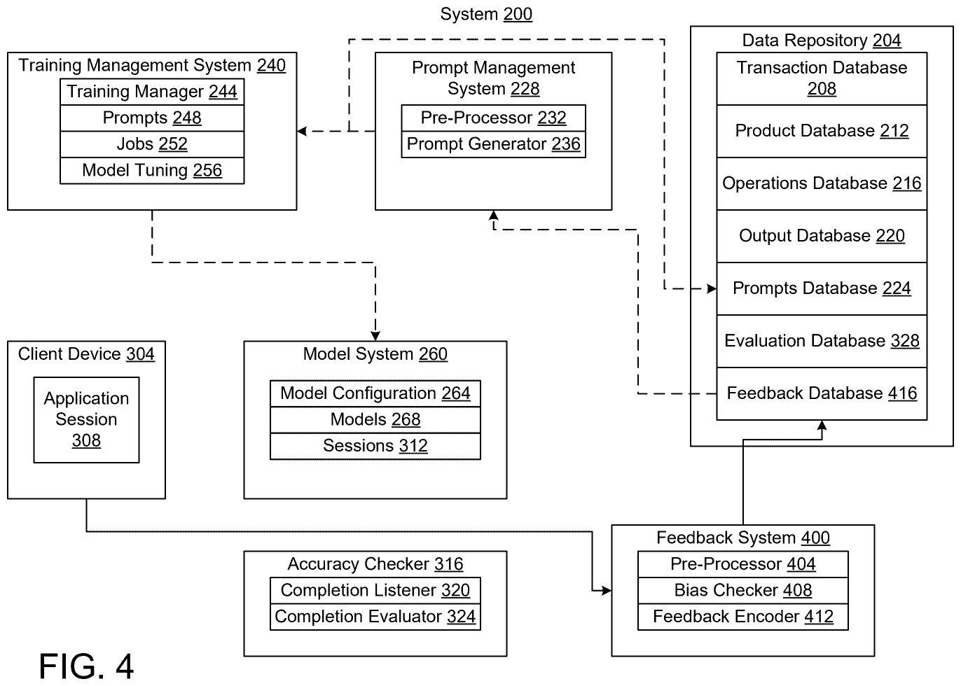

In some implementations, the model system 260 includes at least one sessions database 312. The sessions database 312 can maintain records of application session 308 implemented by client devices 304. For example, the sessions database 312 can include records of prompts provided to the machine learning models 268 and completions generated by the machine learning models 268. As described further with reference to FIG. 4, the system 200 can use the data in the sessions database 312 to fine-tune or otherwise update the machine learning models 268. The sessions database 312 can include one or more session states of the application session 308.

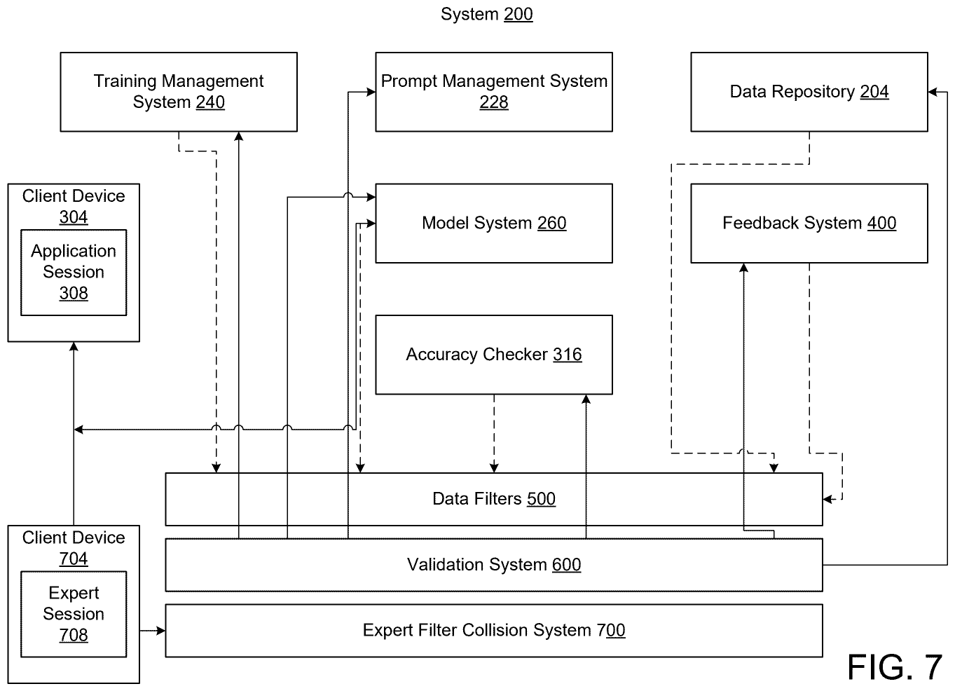

As depicted in FIG. 3, the system 200 can include at least on pre-processor 332. The pre-processor 332 can evaluate the prompt according to one or more criteria and pass the prompt to the model system 260 responsive to the prompt satisfying the one or more criteria, or modify or flag the prompt responsive to the prompt not satisfying the one or more criteria. The pre-processor 332 can compare the prompt with any of various predetermined prompts, thresholds, outputs of algorithms or simulations, or various combinations thereof to evaluate the prompt. The pre-processor 332 can provide the prompt to an expert system (e.g., expert filter collision system 700 described with reference to FIG. 7) for evaluation. The pre-processor 332 (and/or post-processor 336 described below) can be made separate from the application session 308 and/or model system 260, which can modularize overall operation of the system 200 to facilitate regression testing or otherwise enable more effective software engineering processes for debugging or otherwise improving operation of the system 200. The pre-processor 332 can evaluate the prompt according to values (e.g., numerical or semantic/text values) or thresholds for values to filter out of domain inputs, such as inputs targeted for jail-breaking the system 200 or components thereof, or filter out values that do not match target semantic concepts for the system 200.

### Completion Checking

In some implementations, the system 200 includes an accuracy checker 316. The accuracy checker 316 can include one or more rules, heuristics, logic, policies, algorithms, functions, machine learning models, neural networks, scripts, or various combinations thereof to perform operations including evaluating performance criteria regarding the completions determined by the model system 260. For example, the accuracy checker 316 can include at least one completion listener 320. The completion listener 320 can receive the completions determined by the model system 260 (e.g., responsive to the completions being generated by the machine learning model 268 and/or by retrieving the completions from the sessions database 312).

The accuracy checker 316 can include at least one completion evaluator 324. The completion evaluator 324 can evaluate the completions (e.g., as received or retrieved by the completion listener 320) according to various criteria. In some implementations, the completion evaluator 324 evaluates the completions by comparing the completions with corresponding data from the data repository 204. For example, the completion evaluator 324 can identify data of the data repository 204 having similar text as the prompts and/or completions (e.g., using any of various natural language processing algorithms), and determine whether the data of the completions is within a range of expected data represented by the data of the data repository 204.

In some implementations, the accuracy checker 316 can store an output from evaluating the completion (e.g., an indication of whether the completion satisfies the criteria) in an evaluation database 328. For example, the accuracy checker 316 can assign the output (which may indicate at least one of a binary indication of whether the completion satisfied the criteria or an indication of a portion of the completion that did not satisfy the criteria) to the completion for storage in the evaluation database 328, which can facilitate further training of the machine learning models 268 using the completions and output.

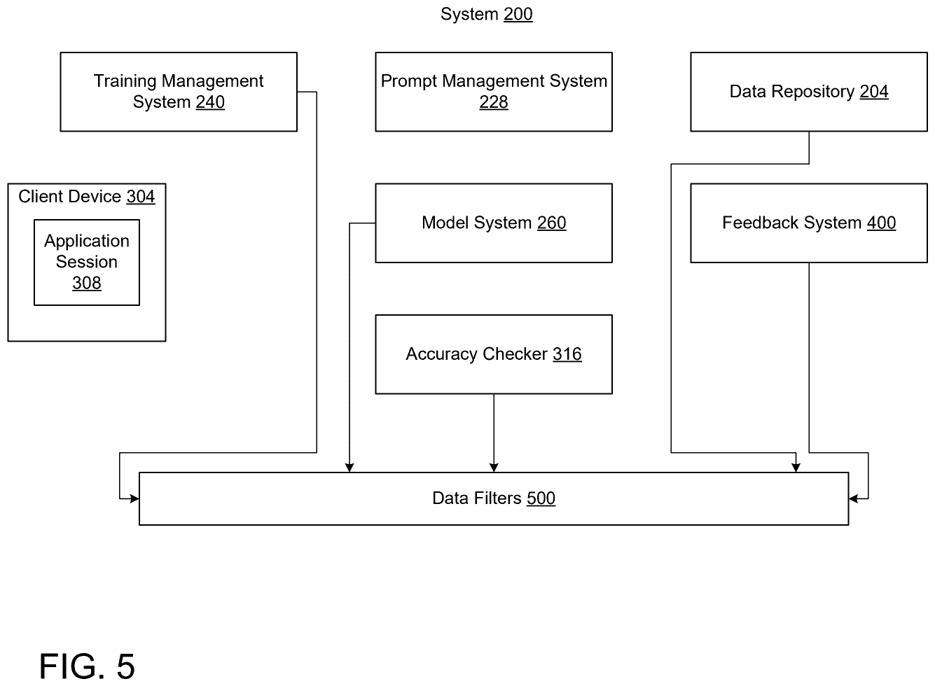

The accuracy checker 316 can include or be coupled with at least one post-processor 336. The post-processor 336 can perform various operations to evaluate, validate, and/or modify the completions generated by the model system 260. In some implementations, the post-processor 336 includes or is coupled with data filters 500, validation system 600, and/or the expert filter collision system 700 described with reference to FIGS. 5-7. The post-processor 336 can operate with one or more of the accuracy checker 316, external systems 344, operations data 348, and/or role models 360 to query databases, knowledge bases, or run simulations that are granular, reliable, and/or transparent.

Referring further to FIG. 3, the system 200 can include or be coupled with one or more external systems 344. The external systems 344 can include any of various data sources, algorithms, machine learning models, simulations, internet data sources, or various combinations thereof. The external systems 344 can be queried by the system 200 (e.g., by the model system 260) or the pre-processor 332 and/or post-processor 336, such as to identify thresholds or other baseline or predetermined values or semantic data to use for validating inputs to and/or outputs from the model system 260. The external systems 344 can include, for example and without limitation, documentation sources associated with an entity that manages items of equipment.

The system 200 can include or be coupled with operations data 348. The operations data 348 can be part of or analogous to one or more data sources of the data repository 204. The operations data 348 can include, for example and without limitation, data regarding real-world operations of building management systems and/or items of equipment, such as changes in building policies, building states, ticket or repair data, results of servicing or other operations, performance indices, or various combinations thereof. The operations data 348 can be retrieved by the application session 308, such as to condition or modify prompts and/or requests for prompts on operations data 348.

### Role-Specific Machine Learning Models

As depicted in FIG. 3, in some implementations, the models 268 can include or otherwise be implemented as one or more role-specific models 360. The models 360 can be configured using training data (and/or have tuned hyperparameters) representative of particular tasks associated with generating accurate completions for the application sessions 308 such as to perform iterative communication of various language model job roles to refine results internally to the model system 260 (e.g., before/after communicating inputs/outputs with the application session 308), such as to validate completions and/or check confidence levels associated with completions. By incorporating distinct models 360 (e.g., portions of neural networks and/or distinct neural networks) configured according to various roles, the models 360 can more effectively generate outputs to satisfy various objectives/key results.

For example, the role-specific models 360 can include one or more of an author model 360, an editor model 360, a validator model 360, or various combinations thereof. The author model 360 can be used to generate an initial or candidate completion, such as to receive the prompt (e.g., via pre-processor 332) and generate the initial completion responsive to the prompt. The editor model 360 and/or validator model 360 can apply any of various criteria, such as accuracy checking criteria, to the initial completion, to validate or modify (e.g., revise) the initial completion. For example, the editor model 360 and/or validator model 360 can be coupled with the external systems 344 to query the external systems 344 using the initial completion (e.g., to detect a difference between the initial completion and one or more expected values or ranges of values for the initial completion), and at least one of output an alert or modify the initial completion (e.g., directly or by identifying at least a portion of the initial completion for the author model 360 to regenerate). In some implementations, at least one of the editor model 360 or the validator model 360 are tuned with different hyperparameters from the author model 360, or can adjust the hyperparameter(s) of the author model 360, such as to facilitate modifying the initial completion using a model having a higher threshold for confidence of outputted results responsive to the at least one of the editor model 360 or the validator model 360 determining that the initial completion does not satisfy one or more criteria. In some implementations, the at least one of the editor model 360 or the validator model 360 is tuned to have a different (e.g., lower) risk threshold than the author model 360, which can allow the author model 360 to generate completions that may fall into a greater domain/range of possible values, while the at least one of the editor model 360 or the validator model 360 can refine the completions (e.g., limit refinement to specific portions that do not meet the thresholds) generated by the author model 360 to fall within appropriate thresholds (e.g., rather than limiting the threshold for the author model 360).

For example, responsive to the validator model 360 determining that the initial completion includes a value (e.g., setpoint to meet a target value of a performance index) that is outside of a range of values validated by a simulation for an item of equipment, the validator model 360 can cause the author model 360 to regenerate at least a portion of the initial completion that includes the value; such regeneration may include increasing a confidence threshold for the author model 360. The validator model 360 can query the author model 360 for a confidence level associated with the initial completion, and cause the author model 360 to regenerate the initial completion and/or generate additional completions responsive to the confidence level not satisfying a threshold. The validator model 360 can query the author model 360 regarding portions (e.g., granular portions) of the initial completion, such as to request the author model 360 to divide the initial completion into portions, and separately evaluate each of the portions. The validator model 360 can convert the initial completion into a vector, and use the vector as a key to perform a vector concept lookup to evaluate the initial completion against one or more results retrieved using the key.

### Feedback Training

FIG. 4 depicts an example of the system 200 that includes a feedback system 400, such as a feedback aggregator. The feedback system 400 can include one or more rules, heuristics, logic, policies, algorithms, functions, machine learning models, neural networks, scripts, or various combinations thereof to perform operations including preparing data for updating and/or updating the machine learning models 268 using feedback corresponding to the application sessions 308, such as feedback received as user input associated with outputs presented by the application sessions 308. The feedback system 400 can incorporate features of the feedback repository 124 and/or feedback trainer 128 described with reference to FIG. 1.

The feedback system 400 can receive feedback (e.g., from the client device 304) in various formats. For example, the feedback can include any of text, speech, audio, image, and/or video data. The feedback can be associated (e.g., in a data structure generated by the application session 308) with the outputs of the machine learning models 268 for which the feedback is provided. The feedback can be received or extracted from various forms of data, including external data sources such as manuals, service reports, or Wikipedia-type documentation.

In some implementations, the feedback system 400 includes a pre-processor 404. The pre-processor 404 can perform any of various operations to modify the feedback for further processing. For example, the pre-processor 404 can incorporate features of, or be implemented by, the pre-processor 232, such as to perform operations including filtering, compression, tokenizing, or translation operations (e.g., translation into a common language of the data of the data repository 204).

The feedback system 400 can include a bias checker 408. The bias checker 408 can evaluate the feedback using various bias criteria, and control inclusion of the feedback in a feedback database 416 (e.g., a feedback database 416 of the data repository 204 as depicted in FIG. 4) according to the evaluation. The bias criteria can include, for example and without limitation, criteria regarding qualitative and/or quantitative differences between a range or statistic measure of the feedback relative to actual, expected, or validated values.

The feedback system 400 can include a feedback encoder 412. The feedback encoder 412 can process the feedback (e.g., responsive to bias checking by the bias checker 408) for inclusion in the feedback database 416. For example, the feedback encoder 412 can encode the feedback as values corresponding to outputs scoring determined by the model system 260 while generating completions (e.g., where the feedback indicates that the completion presented via the application session 308 was acceptable, the feedback encoder 412 can encode the feedback by associating the feedback with the completion and assigning a relatively high score to the completion).

As indicated by the dashed arrows in FIG. 4, the feedback can be used by the prompt management system 228 and training management system 240 to further update one or more machine learning models 268. For example, the prompt management system 228 can retrieve at least one feedback (and corresponding prompt and completion data) from the feedback database 416, and process the at least one feedback to determine a feedback prompt and feedback completion to provide to the training management system 240 (e.g., using pre-processor 232 and/or prompt generator 236, and assigning a score corresponding to the feedback to the feedback completion). The training manager 244 can provide instructions to the model system 260 to update the machine learning models 268 using the feedback prompt and the feedback completion, such as to perform a fine-tuning process using the feedback prompt and the feedback completion. In some implementations, the training management system 240 performs a batch process of feedback-based fine tuning by using the prompt management system 228 to generate a plurality of feedback prompts and a plurality of feedback completion, and providing instructions to the model system 260 to perform the fine-tuning process using the plurality of feedback prompts and the plurality of feedback completions.

### Data Filtering and Validation Systems

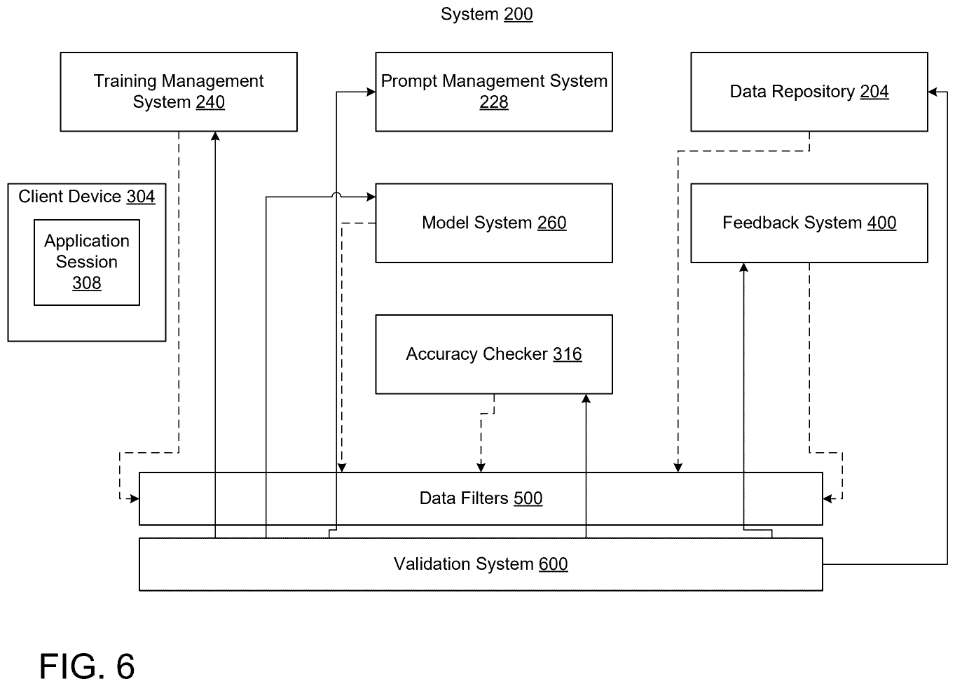

FIG. 5 depicts an example of the system 200, where the system 200 can include one or more data filters 500 (e.g., data validators). The data filters 500 can include any one or more rules, heuristics, logic, policies, algorithms, functions, machine learning models, neural networks, scripts, or various combinations thereof to perform operations including modifying data processed by the system 200 and/or triggering alerts responsive to the data not satisfying corresponding criteria, such as thresholds for values of data. Various data filtering processes described with reference to FIG. 5 (as well as FIGS. 6 and 7) can enable the system 200 to implement timely operations for improving the precision and/or accuracy of completions or other information generated by the system 200 (e.g., including improving the accuracy of feedback data used for fine-tuning the machine learning models 268). The data filters 500 can allow for interactions between various algorithms, models, and computational processes.

For example, the data filters 500 can be used to evaluate data relative to thresholds relating to data including, for example and without limitation, acceptable data ranges, setpoints, temperatures, pressures, flow rates (e.g., mass flow rates), or vibration rates for an item of equipment. The threshold can include any of various thresholds, such as one or more of minimum, maximum, absolute, relative, fixed band, and/or floating band thresholds.

The data filters 500 can enable the system 200 to detect when data, such as prompts, completions, or other inputs and/or outputs of the system 200, collide with thresholds that represent realistic behavior or operation or other limits of items of equipment. For example, the thresholds of the data filters 500 can correspond to values of data that are within feasible or recommended operating ranges. In some implementations, the system 200 determines or receives the thresholds using models or simulations of items of equipment, such as plant or equipment simulators, chiller models, HVAC-R models, refrigeration cycle models, etc. The system 200 can receive the thresholds as user input (e.g., from experts, technicians, or other users). The thresholds of the data filters 500 can be based on information from various data sources. The thresholds can include, for example and without limitation, thresholds based on information such as equipment limitations, safety margins, physics, expert teaching, etc. For example, the data filters 500 can include thresholds determined from various models, functions, or data structures (e.g., tables) representing physical properties and processes, such as physics of psychometrics, thermodynamics, and/or fluid dynamics information.

The system 200 can determine the thresholds using the feedback system 400 and/or the client device 304, such as by providing a request for feedback that includes a request for a corresponding threshold associated with the completion and/or prompt presented by the application session 308. For example, the system 200 can use the feedback to identify realistic thresholds, such as by using feedback regarding data generated by the machine learning models 268 for ranges, setpoints, and/or start-up or operating sequences regarding items of equipment (and which can thus be validated by human experts). In some implementations, the system 200 selectively requests feedback indicative of thresholds based on an identifier of a user of the application session 308, such as to selectively request feedback from users having predetermined levels of expertise and/or assign weights to feedback according to criteria such as levels of expertise.

In some implementations, one or more data filters 500 correspond to a given setup. For example, the setup can represent a configuration of a corresponding item of equipment (e.g., configuration of a chiller, etc.). The data filters 500 can represent various thresholds or conditions with respect to values for the configuration, such as feasible or recommendation operating ranges for the values. In some implementations, one or more data filters 500 correspond to a given situation. For example, the situation can represent at least one of an operating mode or a condition of a corresponding item of equipment.

FIG. 5 depicts some examples of data (e.g., inputs, outputs, and/or data communicated between nodes of machine learning models 268) to which the data filters 500 can be applied to evaluate data processed by the system 200 including various inputs and outputs of the system 200 and components thereof. This can include, for example and without limitation, filtering data such as data communicated between one or more of the data repository 204, prompt management system 228, training management system 240, model system 260, client device 304, accuracy checker 316, and/or feedback system 400. For example, the data filters 500 (as well as validation system 600 described with reference to FIG. 6 and/or expert filter collision system 700 described with reference to FIG. 7) can receive data outputted from a source (e.g., source component) of the system 200 for receipt by a destination (e.g., destination component) of the system 200, and filter, modify, or otherwise process the outputted data prior to the system 200 providing the outputted data to the destination. The sources and destinations can include any of various combinations of components and systems of the system 200.

The system 200 can perform various actions responsive to the processing of data by the data filters 500. In some implementations, the system 200 can pass data to a destination without modifying the data (e.g., retaining a value of the data prior to evaluation by the data filter 500) responsive to the data satisfying the criteria of the respective data filter(s) 500. In some implementations, the system 200 can at least one of (i) modify the data or (ii) output an alert responsive to the data not satisfying the criteria of the respective data filter(s) 500. For example, the system 200 can modify the data by modifying one or more values of the data to be within the criteria of the data filters 500.

In some implementations, the system 200 modifies the data by causing the machine learning models 268 to regenerate the completion corresponding to the data (e.g., for up to a predetermined threshold number of regeneration attempts before triggering the alert). This can enable the data filters 500 and the system 200 selectively trigger alerts responsive to determining that the data (e.g., the collision between the data and the thresholds of the data filters 500) may not be repairable by the machine learning model 268 aspects of the system 200.

The system 200 can output the alert to the client device 304. The system 200 can assign a flag corresponding to the alert to at least one of the prompt (e.g., in prompts database 224) or the completion having the data that triggered the alert.

FIG. 6 depicts an example of the system 200, in which a validation system 600 is coupled with one or more components of the system 200, such as to process and/or modify data communicated between the components of the system 200. For example, the validation system 600 can provide a validation interface for human users (e.g., expert supervisors, checkers) and/or expert systems (e.g., data validation systems that can implement processes analogous to those described with reference to the data filters 500) to receive data of the system 200 and modify, validate, or otherwise process the data. For example, the validation system 600 can provide to human expert supervisors, human checkers, and/or expert systems various data of the system 200, receive responses to the provided data indicating requested modifications to the data or validations of the data, and modify (or validate) the provided data according to the responses.

For example, the validation system 600 can receive data such as data retrieved from the data repository 204, prompts outputted by the prompt management system 228, completions outputted by the model system 260, indications of accuracy outputted by the accuracy checker 316, etc., and provide the received data to at least one of an expert system or a user interface. In some implementations, the validation system 600 receives a given item of data prior to the given item of data being processed by the model system 260, such as to validate inputs to the machine learning models 268 prior to the inputs being processed by the machine learning models 268 to generate outputs, such as completions.

In some implementations, the validation system 600 validates data by at least one of (i) assigning a label (e.g., a flag, etc.) to the data indicating that the data is validated or (ii) passing the data to a destination without modifying the data. For example, responsive to receiving at least one of a user input (e.g., from a human validator/supervisor/expert) that the data is valid or an indication from an expert system that the data is valid, the validation system 600 can assign the label and/or provide the data to the destination.

The validation system 600 can selectively provide data from the system 200 to the validation interface responsive to operation of the data filters 500. This can enable the validation system 600 to trigger validation of the data responsive to collision of the data with the criteria of the data filters 500. For example, responsive to the data filters 500 determining that an item of data does not satisfy a corresponding criteria, the data filters 500 can provide the item of data to the validation system 600. The data filters 500 can assign various labels to the item of data, such as indications of the values of the thresholds that the data filters 500 used to determine that the item of data did not satisfy the thresholds. Responsive to receiving the item of data from the data filters 500, the validation system 600 can provide the item of data to the validation interface (e.g., to a user interface of client device 304 and/or application session 308; for comparison with a model, simulation, algorithm, or other operation of an expert system) for validation. In some implementations, the validation system 600 can receive an indication that the item of data is valid (e.g., even if the item of data did not satisfy the criteria of the data filters 500) and can provide the indication to the data filters 500 to cause the data filters 500 to at least partially modify the respective thresholds according to the indication.

In some implementations, the validation system 600 selectively retrieves data for validation where (i) the data is determined or outputted prior to use by the machine learning models 268, such as data from the data repository 204 or the prompt management system 228, or (ii) the data does not satisfy a respective data filter 500 that processes the data. This can enable the system 200, the data filters 500, and the validation system 600 to update the machine learning models 268 and other machine learning aspects (e.g., generative AI aspects) of the system 200 to more accurately generate data and completions (e.g., enabling the data filters 500 to generate alerts that are received by the human experts/expert systems that may be repairable by adjustments to one or more components of the system 200).

FIG. 7 depicts an example of the system 200, in which an expert filter collision system 700 can facilitate providing feedback and providing more accurate and/or precise data and completions to a user via the application session 308. For example, the expert filter collision system 700 can interface with various points and/or data flows of the system 200, as depicted in FIG. 7, where the system 200 can provide data to the expert filter collision system 700, such as to transmit the data to a user interface and/or present the data via a user interface of the expert filter collision system 700 that can accessed via an expert session 708 of a client device 704. For example, via the expert session 708, the expert filter collision system 700 can enable functions such as receiving inputs for a human expert to provide feedback to a user of the client device 304; a human expert to guide the user through the data (e.g., completions) provided to the client device 304, such as reports, insights, and action items; a human expert to review and/or provide feedback for revising insights, guidance, and recommendations before being presented by the application session 308; a human expert to adjust and/or validate insights or recommendations before they are viewed or used for actions by the user; or various combinations thereof. In some implementations, the expert filter collision system 700 can use feedback received via the expert session as inputs to update the machine learning models 268 (e.g., to perform fine-tuning).

In some implementations, the expert filter collision system 700 retrieves data to be provided to the application session 308, such as completions generated by the machine learning models 268. The expert filter collision system 700 can present the data via the expert session 708, such as to request feedback regarding the data from the client device 704. For example, the expert filter collision system 700 can receive feedback regarding the data for modifying or validating the data (e.g., editing or validating completions). In some implementations, the expert filter collision system 700 requests at least one of an identifier or a credential of a user of the client device 704 prior to providing the data to the client device 704 and/or requesting feedback regarding the data from the expert session 708. For example, the expert filter collision system 700 can request the feedback responsive to determining that the at least one of the identifier or the credential satisfies a target value for the data. This can allow the expert filter collision system 700 to selectively identify experts to use for monitoring and validating the data.

In some implementations, the expert filter collision system 700 facilitates a communication session regarding the data, between the application session 308 and the expert session 708. For example, the expert filter collision system 700, responsive to detecting presentation of the data via the application session 308, can request feedback regarding the data (e.g., user input via the application session 308 for feedback regarding the data), and provide the feedback to the client device 704 to present via the expert session 708. The expert session 708 can receive expert feedback regarding at least one of the data or the feedback from the user to provide to the application session 308. In some implementations, the expert filter collision system 700 can facilitate any of various real-time or asynchronous messaging protocols between the application session 308 and expert session 708 regarding the data, such as any of text, speech, audio, image, and/or video communications or combinations thereof. This can allow the expert filter collision system 700 to provide a platform for a user receiving the data (e.g., customer or field technician) to receive expert feedback from a user of the client device 704 (e.g., expert technician). In some implementations, the expert filter collision system 700 stores a record of one or more messages or other communications between the application session 30 and the expert session 708 in the data repository 204 to facilitate further configuration of the machine learning models 268 based on the interactions between the users of the application session 308 and the expert session 708.

### Building Data Platforms and Digital Twin Architectures

Referring further to FIGS. 1-7, various systems and methods described herein can be executed by and/or communicate with building data platforms, including data platforms of building management systems. For example, the data repository 204 can include or be coupled with one or more building data platforms, such as to ingest data from building data platforms and/or digital twins. The client device 304 can communicate with the system 200 via the building data platform, and can feedback, reports, and other data to the building data platform. In some implementations, the data repository 204 maintains building data platform-specific databases, such as to enable the system 200 to configure the machine learning models 268 on a building data platform-specific basis (or on an entity-specific basis using data from one or more building data platforms maintained by the entity).

For example, in some implementations, various data discussed herein may be stored in, retrieved from, or processed in the context of building data platforms and/or digital twins; processed at (e.g., processed using models executed at) a cloud or other off-premises computing system/device or group of systems/devices, an edge or other on-premises system/device or group of systems/devices, or a hybrid thereof in which some processing occurs off-premises and some occurs on-premises; and/or implemented using one or more gateways for communication and data management amongst various such systems/devices. In some such implementations, the building data platforms and/or digital twins may be provided within an infrastructure such as those described in U.S. patent application Ser. No. 17/134,661 filed Dec. 28, 2020, Ser. No. 18/080,360, filed Dec. 13, 2022, Ser. No. 17/537,046 filed Nov. 29, 2021, and Ser. No. 18/096,965, filed Jan. 13, 2023, and Indian Patent Application number 202341008712, filed Feb. 10, 2023, the disclosures of which are incorporated herein by reference in their entireties.

### III. Generative AI-Based Systems and Methods for Equipment Operations

As described above, systems and methods in accordance with the present disclosure can use machine learning models, including LLMs and other generative AI models, to ingest data regarding building management systems and equipment in various unstructured and structured formats, and generate completions and other outputs targeted to provide useful information to users. Various systems and methods described herein can use machine learning models to support applications for presenting data with high accuracy and relevance.

### Implementing GAI Architectures for Building Management Systems

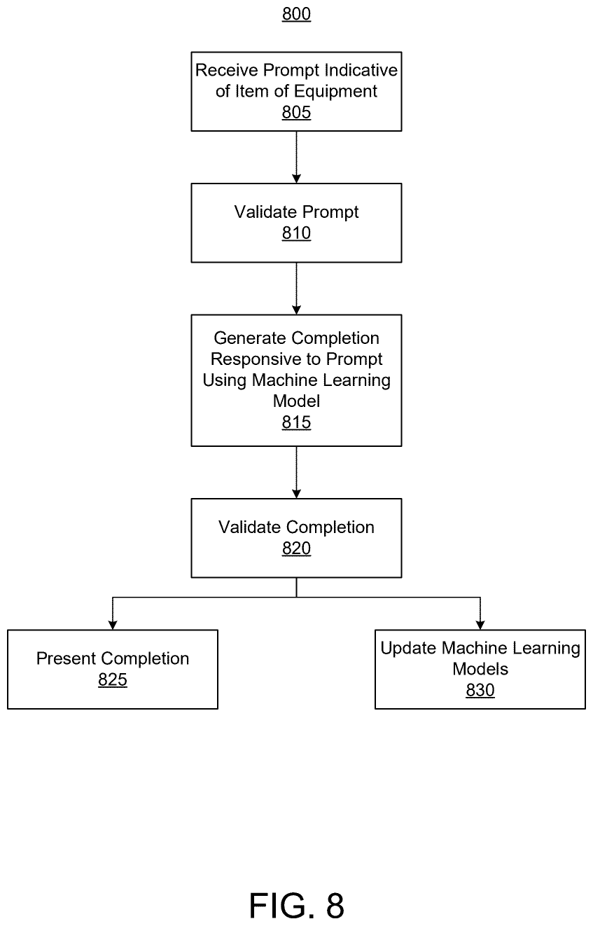

FIG. 8 depicts an example of a method 800. The method 800 can be performed using various devices and systems described herein, including but not limited to the system 100, the system 200, or one or more components thereof. Various aspects of the method 800 can be implemented using one or more devices or systems that are communicatively coupled with one another, including in client-server, cloud-based, or other networked architectures. As described with respect to various aspects of the system 200 (e.g., with reference to FIGS. 3-7), the method 800 can implement operations to facilitate more accurate, precise, and/or timely determination of completions to prompts from users regarding items of equipment, such as to incorporate various validation systems to improve accuracy from generative models.

At 805, a prompt can be received. The prompt can be received using a user interface implemented by an application session of a client device. The prompt can be received in any of various data formats, such as text, audio, speech, image, and/or video formats. The prompt can be indicative of an item of equipment, such as a condition of the equipment (e.g., an error detected or fault condition) or a building management system or component thereof. The prompt can indicate a request for a service to perform for the item of equipment. The prompt can indicate one or more characteristics of the item of equipment. In some implementations, the application session provides a conversational interface or chatbot for receiving the prompt, and can present queries via the application to request information for the prompt. For example, the application session can determine that the prompt indicates a type of equipment, and can request information regarding expected issues regarding the equipment (e.g., via iterative generation of completions and communication with machine learning models).

At 810, the prompt is validated. For example, criteria such as one or more rules, heuristics, models, algorithms, thresholds, policies, or various combinations thereof can be evaluated using the prompt. The criteria can be evaluated to determine whether the prompt is appropriate for the item of equipment. In some implementations, the prompt can be evaluated by a pre-processor that may be separate from at least one of the application session or the machine learning models. In some implementations, the prompt can be evaluated using any one or more accuracy checkers, data filters, simulations regarding operation of the item of equipment, or expert validation systems; the evaluation can be used to update the criteria (e.g., responsive to an expert determining that the prompt is valid even if the prompt includes information that does not satisfy the criteria, the criteria can be updated to be capable of being satisfied by the information of the prompt). In some implementations, the prompt is modified according to the evaluation; for example, a request can be presented via the application session for an updated version of the prompt, or the pre-processor can modify the prompt to make the prompt satisfy the one or more criteria. The prompt can be converted into a vector to perform a lookup in a vector database of expected prompts or information of prompts to validate the prompt.

At 815, at least one completion is generated using the prompt (e.g., responsive to validating the prompt). The completion can be generated using one or more machine learning models, including generative machine learning models. For example, the completion can be generated using a neural network comprising at least one transformer, such as a GPT model. The completion can be generated using image/video generation models, such as GAN and/or diffusion models. The completion can be generated based on the one or more machine learning models being configured (e.g., trained, updated, fine-tuned, etc.) using training data examples representative of information for items of equipment, including but not limited to unstructured data or semi-structured data such as service technician reports, operating manuals, technical data sheets, etc. Prompts can be iteratively received and completions iteratively generated responsive to the prompts as part of an asynchronous and/or conversational communication session.

In some implementations, generating the prompt comprises using a plurality of machine learning models, which may be configured in similar or different manners, such as by using different training data, model architectures, parameter tuning or hyperparameter fine tuning, or various combinations thereof. In some implementations, the machine learning models are configured in a manner representative of various roles, such as author, editor, validation, external data comparison, etc. roles. For example, a first machine learning model can operate as an author model, such as to have relatively fewer/lesser criteria for generating an initial completion responsive to the prompt, such as to require relatively lower confidence levels or risk criteria. A second machine learning model can be configured to have relatively greater/higher criteria, such as to receive the initial completion, process the initial completion to detect one or more data elements (e.g., tokens or combinations of tokens) that do not satisfy criteria of the second machine learning model, and output an alert or cause the first machine learning model to modify the initial completion responsive to the valuation. For example, the editor model can identify a phrase in the initial completion that does not satisfy an expected value (e.g., expected accuracy criteria determined by evaluating the prompt using a simulation), and can cause the first machine learning model to provide a natural language explanation of factors according to which the initial completion was determined, such as to present such explanations via the application session. The machine learning models can evaluate the completions according to bias criteria. The machine learning models can store the completions and prompts as data elements for further configuration of the machine learning models (e.g., positive/negative examples corresponding to the prompts).

At 820, the completion can be validated. The completion can be validated using various processes described for the machine learning models, such as by comparing the completion to any of various thresholds or outputs of databases or simulations. For example, the machine learning models can configure calls to databases or simulations for the item of equipment indicated by the prompt to validate the completion relative to outputs retrieved from the databases or simulations. The completion can be validated using accuracy checkers, bias checkers, data filters, or expert systems.

At 825, the completion is presented via the application session. For example, the completion can be presented as any of text, speech, audio, image, and/or video data to represent the completion, such as to provide an answer to a query represented by the prompt regarding an item of equipment or building management system. The completion can be presented via iterative generation of completions responsive to iterative receipt of prompts. The completion can be present with a user input element indicative of a request for feedback regarding the completion, such as to enable the prompt and completion to be used for updating the machine learning models.

At 830, the machine learning model(s) used to generate the completion can be updated according to at least one of the prompt, the completion, or the feedback. For example, a training data element for updating the model can include the prompt, the completion, and the feedback, such as to represent whether the completion appropriately satisfied a user's request for information regarding the item of equipment. The machine learning models can be updated according to indications of accuracy determined by operations of the system such as accuracy checking, or responsive to evaluation of completions by experts (e.g., responsive to selective presentation and/or batch presentation of prompts and completions to experts).

### Machine Learning-Model Based Automated Resource Allocation for Building Management Systems

Various devices (e.g., items of equipment) can be used in buildings and building management systems to perform functions for the building. Such devices can include, for example and without limitation, sensors, controllers, HVAC-R equipment, network communications equipment, service providers, cloud servers, security devices, access controllers, data platforms (including but not limited to edge devices, such as gateways and/or smart gateways), automation systems, or various combinations thereof.

Such devices can utilize machine learning processes to perform functions (e.g., tasks, workloads, etc.) for the building. Each device may utilize a respective machine learning process to complete the functions. For example, each device may input data into a machine learning model to generate outputs for completing the functions. As the number of devices and machine learning models increase, so does the complexity of the building management system. For example, the devices may have variations or discrepancies between device functionality, location, available resources, type, latency, status, and other such characteristics. Additionally, each model may have similar or other variations that may change based on the type of device the model is located on. Some systems may not have a capability to efficiently determine which device to assign a workload and further which model to utilize for the workload. Due to the growing complexity and optionality, inefficient usage of resources, increased latency (e.g., due to reliance on cloud-based computational resources or other resources remote from where input data for machine learning models is initially retrieved or detected, which can result in long network communications for data communication and processing and/or outputs being provided to edge devices after their content can be used), and an unsynchronized system, among other technical deficiencies, may result.

Systems and methods in accordance with the present disclosure can allow building management systems to assign workload for each device based on device parameters (e.g., capability, status, available resources, etc.), model attributes, and other system inputs. In this way, the building management system may orchestrate usage of multiple models and systems while improving resource efficiency. For example, the building management system may act as an orchestration system or layer (e.g., a watchdog system) that optimizes and orchestrates workload across multiple machine learning (e.g., artificial intelligence) models and devices. The building management system may trigger activation of (e.g., call, send data to) a device, model, or process to complete a task or a portion of a task (e.g., workload, function). The building management system may adjust one or more rules for determining which device, model, or process to trigger based on determined outcomes (e.g., one or more performance metrics) and/or feedback. For example, the building management system may determine to focus on a desired end result, a desired environmental impact, a desired time to result (e.g., latency), device capability, device availability, feedback from the system (e.g., the devices), or input from other systems, among other metrics, and adjust the one or more rules to prioritize the desired end result. The building management system may assign, create, pause, or destroy one or more machine learning models per device, system, or task based on the desired end result and/or in response to system inputs, feedback, performance, or other indicators. The building management system may direct data flows (e.g., data associated with one or more workloads, data including one or more machine learning models) to each device or system.

In some examples, the building management system may obtain an input from an item of equipment. The building management system may determine which device and which model to utilize for performing a task associated with the input. To do so, the building management system may have data regarding the devices, such as where the devices correspond to one or more machine learning systems (e.g., a pool of computational resources that can be operated on one or more devices to implement one or more machine learning models), and can use the data to determine how to perform one or more functions for processing the input. The data may include a resources matrix detailing various metrics about each system of the pool of neural network systems. The building management system may provide the input to an orchestrator (e.g., a processor, a model, a neural network, etc.) to determine, based on the output of the orchestrator, which system, and which model to utilize. The building management system may send the selected model and/or an indication of the selected model and the input to the selected system. In response, the selected system may perform the task using the selected model. In some embodiments, the selected system may include the model and the building management system may send the input to the selected system.

In some examples, the building management system can evaluate one or more trigger (e.g., trip-wire) thresholds for activation of one or more models for processing the input. The trigger thresholds can be used to selectively operate the one or more models to more effectively manage computational resources for using the one or more models. For example, the trigger thresholds can relate to content or information represented by the input. The system can, for example, determine that the input satisfies a trigger threshold. The trigger threshold can be different per input (e.g., per task, workload, function). The trigger threshold can be associated with a number of resources (e.g., estimated resources to complete the task).

The trigger threshold may include and/or be associated with a trigger condition. The trigger condition may be any condition to be satisfied to activate the one or more models for processing the input. For example, a trigger threshold may include a trigger condition such that when the trigger condition is satisfied, a machine learning deployment process is initiated. In some embodiments, the trigger condition may be based on the output of a node of the system. A deployment node may be configured to evaluate the output from a node of the system, and determine that the trigger condition is satisfied. The deployment node may then deploy a selected machine learning model to the selected resource.

Responsive to determining the input satisfies the trigger threshold, the building management system can select a resource to deploy for implementing a given machine learning model, such as to provide at least one of the machine learning model (or configuration thereof) or data for operation of the machine learning model to the selected resource. To do so, the building management system can determine an output score for each resource of the plurality of resources. The building management system can transmit (e.g., direct, orchestrate) data flow to the selected resource.

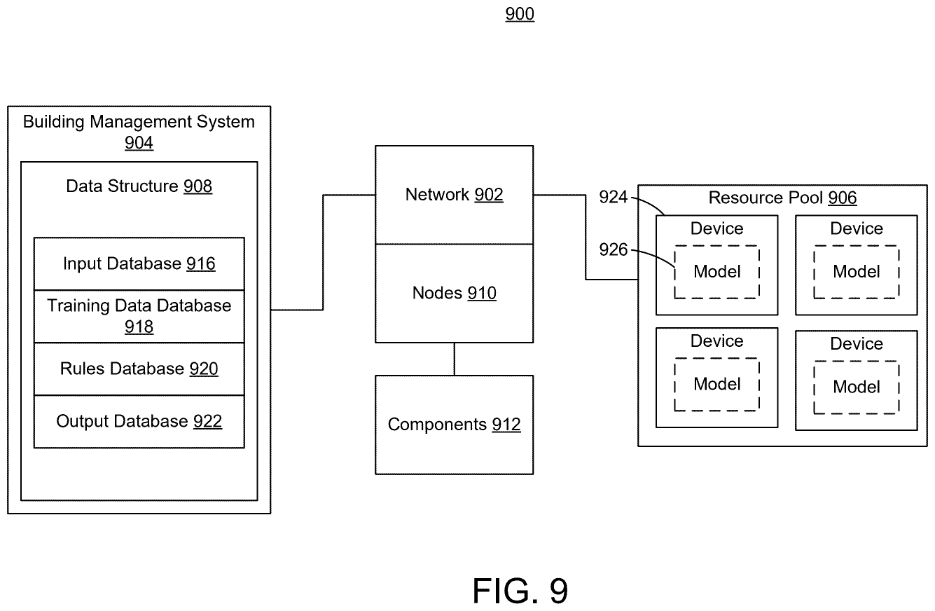

FIG. 9 depicts an example of a system 900. The system 900 can incorporate any of various systems and devices described herein, including but not limited to the system 200. For example, the system 900 can include a building management system 904 that includes one or more features of the system 200. The building management system 904 can include or be coupled with one or more building data platforms, which can include components such as gateways, databases, digital twins, communication networks, or various combinations thereof.

The building management system 904 can maintain a data structure 908 representative of one or more components 912 (e.g., items of equipment) coupled with the building management system 904. The data structure 908 can include any of a variety of structured and/or unstructured data, including but not limited to graph data, metadata, queryable databases, or various combinations thereof. The data structure 908 can indicate one or more relationships between components 912. The data structure 908 can indicate at least one of a position or a function of a given component 912. The position can indicate a physical location of the component 912, or a logical location (e.g., a network location or device based on where the component 912 is connected to the network 902 of the building management system 904). The function of the component 912 can include, for example, one or more operations that the component 912 is to perform, such as real-world actions, data processing operations, data sensing or measuring, or various combinations thereof. The function of the component 912 can indicate at least one of data to be used by the component 912 (e.g., to be received as input) or data to be outputted by the component 912. The building management system 904 can update the data structure 908 responsive to one or more components 912 being connected with the building management system 904 (e.g., via network 902).

The data structure 908 can include, maintain, or manage an input database 916, a training database 918, a rules database 920, and an output database 922. For example, the building management system 904 can communicate or interact with the network 902 to populate the databases 916-924 with values. The input database 916 can include input data associated with workloads being performed or in a queue waiting to be performed, or for input to one or more machine learning models in order to perform the workload(s) for which the machine learning models are deployed. The training database 918 can include training data associated with training and/or implementation of one or more machine learning models, such as on one or more resources of a resource pool 906. The rules database 920 can include one or more rules, algorithms, heuristics, models, or other functions for determination of one or more of an availability, resources, status, historical data, a data stream, a workload, or a respective model 926 for deployment on selected device(s) 924 of the resource pool 906. The rules database 920 can include or be generated based on data regarding a resources matrix. The resources matrix can include one or more resource metrics for each device 924 of the resource pool 906. The data can be updated periodically or responsive to an event (e.g., receiving feedback from the resource pool 906, receiving updates about the devices 924 from the resource pool 906). The rules database 920 can include one or more rules or settings for how to optimize workloads. For instance, the one or more rules can include weight or priority for each device 924. In some cases, the rules can be updated based on a desired outcome (e.g., scale, operating cost, time to completion, carbon footprint, etc.). The building management system can update the rules based on feedback on system performance. The output database 922 can include output from one or more machine learning models.

The network 902 can include or be coupled with any of various nodes 910. The nodes 910 can represent devices in a building having network capabilities and/or that support network operations. For example, the nodes 910 can represent (e.g., in data structure 908) network platforms and/or computing platforms coupled with the building management system 904.

The components 912 can include any of various items of equipment described herein that can perform operations in a building. For example, the components 912 can include any of various sensors, controllers, HVAC-R equipment, network communications equipment, security devices, access controllers, data platforms, automation systems, or various combinations thereof. One or more components 912 can include network communications electronics to communicate with the building management system 904 via the network 902.

Referring further to FIG. 9, the resource pool 906 can be computing resources including one or more devices 924 (e.g., neural network systems, edge-connected devices, sensors, gateway devices, servers, cloud systems). The devices 924 can be similar or identical to components 912. The devices 924 can implement an edge system that can, in some implementations, be a software service added to the network 902 that can run on one or multiple different nodes 910 of the network 902. The software service can be made up in terms of components, e.g., integration components, connector components, a building normalization component, software service components, endpoints, etc. The various components can be deployed on various nodes 910 to implement an edge platform that facilitates communication between a cloud or other off-premises platform and the local subsystems of the building. The edge platform techniques described herein can be implemented for supporting off-premises platforms such as servers, computing clusters, computing systems located in a building other than the edge platform, or any other computing environment.

The devices 924 can include software and/or firmware components to implement, for example, control applications, analytics applications, machine learning models, artificial intelligence systems, user interface applications, etc. The components can have requirements or component metrics (e.g., a requirement that another component be present or be in communication with the component, total processing capability, a particular level of processing resource availability, a particular level of storage availability, etc.). In some implementations, the components (e.g., software and/or firmware components, such as services implemented by the software and/or firmware components) can be moved around the nodes 910 of the network 902 and/or the devices 924 based on available data, processing hardware, memory devices, etc. The various services can be dynamically relocated around the nodes of the network based on the requirements for each service. In some implementations, an orchestrator run in a cloud platform of the building management system 904, orchestrators distributed across the nodes 910, and/or the service itself can make determinations to dynamically relocate the service around the nodes 910 and/or the cloud platform.

The building management system 904 (e.g., the orchestrator of the building management system) can dynamically relocate the service and/or assign the service to the nodes 910 and/or the devices 924 based on the resources matrix of the rules database 920. For instance, the resources matrix can detail the various component metrics or requirements of each device 924 (e.g., neural network system, system). The building management system 904 can update the resources matrix based on changes (e.g., adjustments) to each of the devices 924. For example, the devices 924 can change an availability metric over time. The devices 924 can complete one or more services or workloads, freeing up processing resources, such that the devices 924 can have more available resources for another service. The devices 924 can come online or go offline based on a periodic event (e.g., maintenance), an unforeseen event (e.g., a malfunction), or another type of event (e.g., new device introduced to the system). The devices 924 can send a message via the network 902 to the building management system 904 including the availability metric and other resource metrics (e.g., in real-time, periodically, when the change occurs, etc.). The building management system 904 can update the matrix in the rules database 920 based on received messages from the devices 924. In some cases, the devices 924 can send feedback in the message and the building management system 904 can adjust the matrix based on the feedback.

The resource pool 906 can be used to deploy a plurality of machine learning models (e.g., any of various machine learning models described herein). The machine learning models can include, for example, neural networks configured to perform operations on data received from components 912 and/or devices 924. As noted above, execution of any of various such machine learning models can have varying resource usage characteristics, such that the building management system 904 can using the data structure 908 to more effectively deploy and execute the machine learning model(s) to perform operations on data from the components 912 and/or device 924 in accordance with such resource usage characteristics.

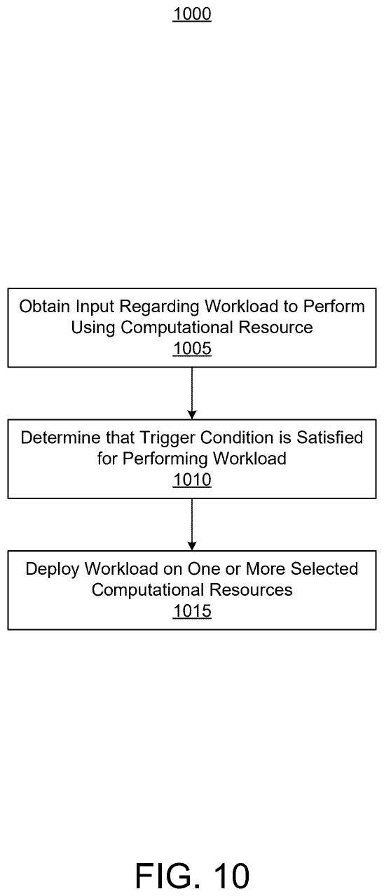

FIG. 10 is a flow diagram of a method of implementing artificial intelligence architectures and validation processes for machine learning algorithms for building management systems. The method 1000 can be performed using various devices and systems described herein, including but not limited to the system 100, the system 200, or the system 900, or one or more components thereof. Various aspects of the method 1000 can be implemented using one or more devices or systems that are communicatively coupled with one another, including in client-server, cloud-based, or other networked architectures. As described with respect to various aspects of the system 200 (e.g., with reference to FIGS. 3-7) and the system 900, the method 1000 can implement operations to facilitate more efficient, accurate, precise, and/or timely completion of workloads by managing resource allocation and orchestrating task distribution.

At 1005, a data processing system can obtain input regarding a workload to be implemented by one or more computing resources. In some cases, the input can include a workload (e.g., a task) to be performed for (e.g., on behalf of or to facilitate operation of) an item of equipment.

In some examples, the data processing system can receive operation data regarding one or more resources of a plurality of computational resources (e.g., of a pool of computational resources on which machine learning model(s) can be deployed), as well as updates for the operation data from the computational resources, with respect to performing the workload. In some cases, the operation data can include one or more of an availability, resources, a status, historical data, a data stream, or a workload for each computational resource. In some examples, the computational resources can include two or more neural networks systems. The two or more neural network systems can each be associated with one or more of a sensor, an edge device, a gateway device, a server, or a cloud system.

At 1010, the data processing system can determine that a trigger condition is satisfied, in order to perform the workload. The data processing system can evaluate one or more trigger conditions with respect to the workload and/or data representative of the workload. For example, the data processing system can determine, based on at least one of a type or a value of the input and/or the workload, that the one or more trigger conditions are satisfied, such as to determine that the workload is of a type to be implemented using the one or more computational resources, such as to be a higher demand workload and/or a workload for implementing using one or more machine learning models.

Before deploying the workload, the workload capability of each computational resource (e.g., computing device) may be evaluated based on the performance criteria of the workload. The workload capability may be associated with the amount (e.g., percentage, volume, etc.) of the workload that can be performed by the computational resource. Depending on the workload capability, computational resources may be selected to perform the workload. For example, for computational resources with low workload capability, more computational resources may be selected to deploy the workload. As another example, for computational resources with a high workload capability, fewer computational resources may be selected.

At 1015, the workload can be deployed on one or more selected computational resources. The computational resource(s) can be selected and/or configured based on at least one of an orchestrator or an optimizer, which can be configured according to one or more rules relating to machine learning model deployment and/or the operation data. In some examples, the one or more rules includes at least one of a weight, a priority, a cost of operation, a time period for completion, and a carbon footprint for each neural network system of the pool of neural network systems. In some cases, the data can include a resources matrix. The resources matrix can include one or more resource metrics for the computational resources.

After deploying the workload, the building management system may receive feedback indicative of the true workload capability of the computational resources to deploy the workload. The feedback may be based on a user input, and/or an automated feedback process (e.g., from the orchestrator or other system component). For example, the feedback may indicate that the computational resources were not enough to deploy the machine learning model. The selection of computational resources (e.g., by the orchestrator or the optimizer) may be updated based on the feedback. For example, if the feedback indicates that the computational resources were not enough to deploy the model, additional resources may be deployed.

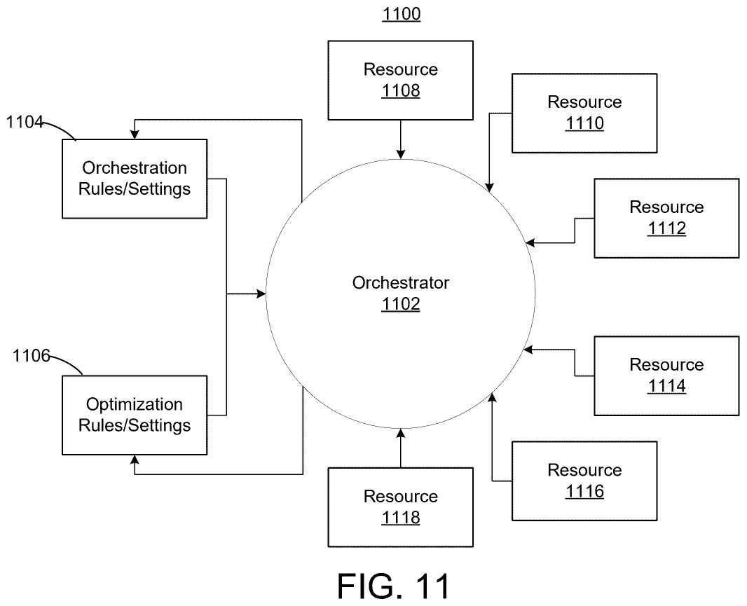

FIG. 11 is a block diagram of an example of a machine learning model-based system 1100 for resource allocation applications. The system 1100 or components thereof can be implemented using any of various systems and devices described herein, such as the system 100, the system 200, the system 900, or any one or more components thereof. The system 1100 can be used to more effectively direct execution of machine learning models to distributed computing resources according to various use of the computing resources.

The system 1100 can include an orchestrator 1102. The orchestrator 1102 can include any one or more functions, rules, heuristics, algorithms, machine learning models, logic, computer-executable code, or various combinations thereof to perform operations for directing performance of any of various machine learning models on any of various resources 1108, 1110, 1112, 1114, 1116, 1118, which can be various respective computing systems, which can be disparately located and communicatively coupled via any of various networks. The computing systems can include devices and/or servers having varied amounts of computational resources available for processing data using the machine learning models.

The orchestrator 1102 can determine where (e.g., which device(s) and/or resources for machine learning models) to deploy one or more machine learning models to process one or more inputs, according to orchestration settings 1104. The orchestration settings 1104 can indicate how to direct data, inputs, and/or machine learning model settings (e.g., weights and/or biases of neural networks; different layers of neural networks) to the device(s).

The orchestrator 1102 can identify one or more machine learning models to process the one or more inputs. Based on the orchestration settings 1104, one or more characteristics of the inputs, and/or one or more characteristics of the machine learning models, the orchestrator 1102 may determine one or more machine learning models to be used for processing the inputs. For example, based on one or more performance criteria of the machine learning models, the orchestrator 1102 may identify a machine learning model for processing the inputs.

The orchestrator 1102 can select which device(s) to use for the one or more machine learning models according to optimization settings 1106. The optimization settings 1106 can be used by the orchestrator 1102 to determine how criteria such as resource usage, latency, speed of completion of tasks, energy criteria, or various combinations thereof can be evaluated to select the device(s). The orchestrator 1102 can include operations such as initializing, pausing, and/or terminating (e.g., de-allocating memory for) any of the machine learning models according to the orchestration settings 1104 and/or the optimization settings 1106, such as to reach target outcomes and/or in response to overall inputs, needs, feedback, and/or performance of the system 1100 or various components thereof.

The orchestrator 1102 can select which device(s) to use for the one or more machine learning models according to a priority score of each device. The priority score may be based on the capability of the device(s) to execute the machine learning model relative to additional processes being performed by the device(s). For example, if a device is already executing multiple processes, its priority score may be lower relative to a device that is not concurrently executing multiple processes.

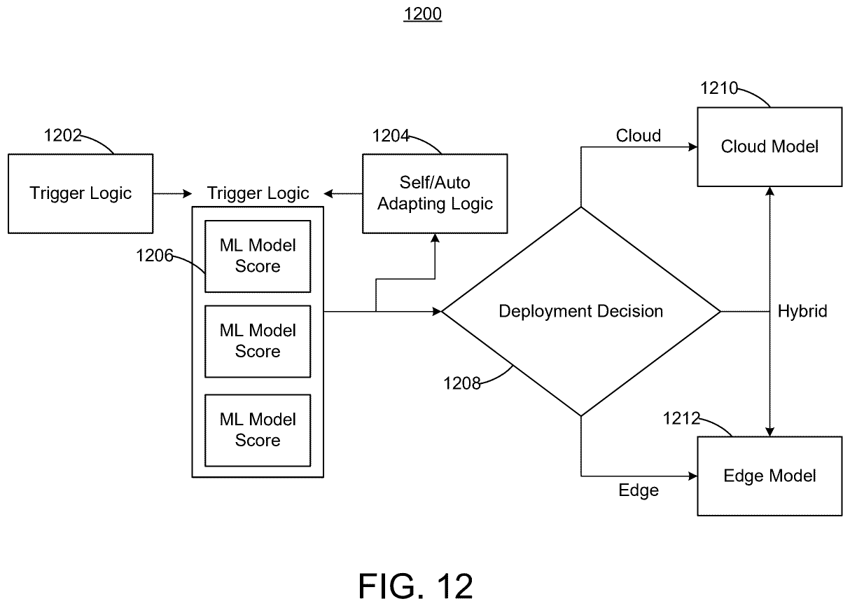

FIG. 12 is a block diagram of an example of a machine learning model-based process 1200 for resource allocation applications. The process 1200 can be implemented using any of various systems described, such as the system 100, the system 200, the system 900, or any one or more components thereof.

The process 1200 can include evaluating trigger logic 1202 based on input generated by a device, such as an item of equipment. The trigger logic 1202 can represent criteria for initiating processing of the input. For example, the trigger logic 1202 can correspond to a feature of the input, such as whether the input includes appropriate data for processing by a machine learning model (e.g., an image for person detection represents a person). The trigger logic 1202 can be evaluated using model scores 1206 of any one or more machine learning models, such as scores representative of the capability of respective machine learning models to meet performance criteria for operating on the inputs. The trigger logic 102 can be evaluated using priority scores of any one or more computational resources. The priority score may correspond to the capability of a computational resource to execute the respective machine learning models to meet performance criteria for operating on the inputs. The priority scores may be applied to nodes of the system. For example, the deployment node may select one or more nodes based on a priority score of the nodes. The priority score of the nodes may be based on the capability of each respective node to execute the machine learning model. The trigger logic 1202 can be updated using adaptive logic 1204, which can update the trigger logic 1202 (e.g., update one or more rules and/or machine learning models of the trigger logic 1202) according to data relating to the machine learning models available for deployment to process the input.

The process 1200 can include determining, responsive to the trigger logic 1202 being satisfied and according to the model scores 1206, one or more deployment decisions 1208 for processing the input. For example, the deployment decision 1208 can include at least one of selecting a cloud model 1210 according to the deployment decision 1208, selecting an edge model 1212 according to the deployment decision 1208, or a combination thereof (e.g., deployment a machine learning model in a hybrid arrangement, such as to execute one or more first layers or sub-components of the machine learning model using the cloud model 1210 and one or more second layers or sub-components using the edge model 1212).

The process 1200 can include a machine learning deployment process. The machine learning deployment process may include identifying (e.g., based on the trigger logic 1202) a deployment decision 1208 for processing the input. The machine learning deployment process may include selecting (e.g., based on the priority scores), one or more computational resources to execute the machine learning model. The machine learning deployment process may include executing the machine learning model on the computational resources to process the inputs.

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied, and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions, and arrangement of the exemplary embodiments without departing from the scope of the present disclosure.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general-purpose computer, special purpose computer, or special purpose processing machines to perform a certain function or group of functions.

Although the figures show a specific order of method steps, the order of the steps may differ from what is depicted. Two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps.

In various implementations, the steps and operations described herein may be performed on one processor or in a combination of two or more processors. For example, in some implementations, the various operations could be performed in a central server or set of central servers configured to receive data from one or more devices (e.g., edge computing devices/controllers) and perform the operations. In some implementations, the operations may be performed by one or more local controllers or computing devices (e.g., edge devices), such as controllers dedicated to and/or located within a particular building or portion of a building. In some implementations, the operations may be performed by a combination of one or more central or offsite computing devices/servers and one or more local controllers/computing devices. All such implementations are contemplated within the scope of the present disclosure. Further, unless otherwise indicated, when the present disclosure refers to one or more computer-readable storage media and/or one or more controllers, such computer-readable storage media and/or one or more controllers may be implemented as one or more central servers, one or more local controllers or computing devices (e.g., edge devices), any combination thereof, or any other combination of storage media and/or controllers regardless of the location of such devices.

What is claimed is:

1. A method of deploying machine learning models in building management systems, comprising:
receiving, by one or more processors of a building management system, data from one or more devices of the building management system, the one or more devices corresponding to a plurality of computational resources associated with the building management system, the plurality of computational resources including an edge device associated with the building management system and a cloud server associated with the building management system;
generating, by the one or more processors, a first output responsive to the data;
detecting, by the one or more processors, that a trigger condition is satisfied responsive to detecting a target characteristic from the first output; and
triggering, by the one or more processors responsive to detecting that the trigger condition is satisfied, a machine learning model deployment process comprising:
identifying, by the one or more processors, at least one machine learning model for processing at least one of the data or the first output;
selecting, by the one or more processors, according to one or more resource criteria regarding the at least one machine learning model, from the plurality of computational resources associated with the building management system, one or more computational resources on which to deploy the at least one machine learning model on the one or more computational resources; and
causing the at least one machine learning model to process the at least one of the data or the first output using the one or more computational resources.

2. The method of claim 1, wherein the one or more resource criteria represent, for the plurality of computational resources, at least one of an energy usage for operating the at least one machine learning model, an environmental impact score for operating the at least one machine learning model, a device capability relative to operating the at least one machine learning model, a resource availability relative to operating the at least one machine learning model, or a network resource usage for communicating the at least one of the data or the first output to the one or more computational resources.

3. The method of claim 1, further comprising:
monitoring, by the one or more processors, completion of processing of the at least one of the data or the first output, by the at least one machine learning model; and
modifying, by the one or more processors, the one or more computational resources according to the monitoring.

4. The method of claim 1, further comprising:
receiving, by the one or more processors, feedback indicative of a capability of the one or more computational resources to deploy the at least one machine learning model; and
updating, by the one or more processors, the selection of the one or more computational resources responsive to the feedback.

5. The method of claim 1, wherein selecting the one or more computational resources comprises retrieving, by the one or more processors, a priority score assigned to the one or more computational resources, the priority score corresponding to a capability of the one or more computational resources to execute the at least one machine learning model relative to one or more additional processes being performed by the one or more computational resources.

6. The method of claim 1, further comprising:
evaluating, by the one or more processors, execution of the at least one machine learning model; and
updating, by the one or more processors, the one or more resource criteria according to the evaluation.

7. The method of claim 1, wherein the plurality of computational resources comprise the one or more processors.

8. The method of claim 1, wherein the plurality of computational resources comprise:
an edge device coupled with an internal network of the building management system; and
a cloud server coupled with an external network coupled with the internal network, the cloud server having a greater computational capacity than the edge device.

9. The method of claim 1, wherein the target characteristic comprises a type of data indicated by the first output.

10. The method of claim 1, further comprising transmitting, by the one or more processors, the at least one machine learning model to the one or more computational resources.

11. The method of claim 1, wherein the data comprises at least one of sensor data generated by a sensor of the one or more devices, a input received via a user interface of the one or more devices, equipment data generated by an item of equipment of the one or more devices, an output from a machine learning model operated on the one or more devices, or an output from a generative artificial intelligence (AI) machine learning model implemented by the one or more devices.

12. A building management system, comprising:
a plurality of computational resources arranged as a plurality of nodes coupled by a network, each computational resource of the plurality of computational resources comprising one or more processors and memory for use by one or more corresponding nodes of the plurality of nodes; and
the plurality of nodes comprising a deployment node configured to:
evaluate an output from a given node of the plurality of nodes to determine that a trigger condition for deployment of at least one machine learning model is satisfied, the at least one machine learning model to process the output;
determine, responsive to the trigger condition being satisfied, a capability of each node of the plurality of nodes to deploy the at least one machine learning model to process the output;
select, according to the capability of each node and one or more resource criteria, from the plurality of nodes, one or more nodes on which to deploy the at least one machine learning model; and
cause the one or more nodes to operate the at least one machine learning model to process the output.

13. The building management system of claim 12, wherein the plurality of nodes comprise a sensor, an edge device, and a cloud server.

14. The building management system of claim 12, wherein the one or more resource criteria represent, for deployment of the at least one machine learning model on the one or more nodes, at least one of an energy usage, an environmental impact score, or a network resource usage for communication of the output to the one or more nodes.

15. The building management system of claim 12, wherein the deployment node is configured to:
monitor completion of the operation of the at least one machine learning model; and
modify the selection of the one or more nodes according to the monitoring of the completion.

16. The building management system of claim 12, wherein the deployment node is configured to select the one or more nodes according to a priority score assigned to the one or more nodes, the priority score corresponding to a capability of the one or more nodes to execute the at least one machine learning model relative to one or more additional processes being performed by the one or more nodes.

17. The building management system of claim 12, wherein the deployment node is configured to determine that the trigger condition is satisfied responsive to the output having a characteristic matching a target characteristic for use of the at least one machine learning model.

18. A system, comprising:
one or more processors configured to:
receive data from an item of equipment of a building management system;
determine that the data is to be processed by at least one machine learning model;
retrieve, for each computing device of a plurality of computing devices of the building management system, an indication of a workload capability of each computing device of the plurality of computing devices during at least one of a current period or a future period;
retrieve one or more performance criteria regarding execution of the at least one machine learning model;
select, according to (1) the indication of the workload capability of each computing device of the plurality of computing devices and (2) the one or more performance criteria, one or more computing devices of the plurality of computing devices; and
cause the one or more computing devices to deploy the at least one machine learning model to process the data from the item of equipment using the at least one machine learning model.

19. The system of claim 18, wherein the plurality of computing devices comprise a sensor, one or more edge devices of the building management system, and a cloud server coupled with the one or more edge devices.

20. The system of claim 18, wherein the one or more performance criteria comprise at least one of an energy usage score, an environmental impact score, or a network communication score.
